(19) United States
(12) Patent Application Publication
(10) Pub. No.: US 2010/0043062 A1
(43) Pub. Date: Feb. 18, 2010

(54) Methods and Systems for Management of Image-Based Password Accounts

(76) Inventors: Samuel Wayne Alexander, Portland, OR (US); Scott A. Blomquist, Portland, OR (US); Koesmanto Leka Bong, Portland, OR (US); Jason Allyn Grlicky, Portland, CO (US); Adam Paul Kuert, Portland, CO (US); Christopher James Lee, Portland, OR (US); Steven L. Osborn, II, Sand Springs, OK (US); James Luke Sontag, Portland, OR (US); Benjamin Joel Stover, Portland, OR (US)

Correspondence Address: WILSON, SONSINI, GOODRICH & ROSATI, 650 PAGE MILL ROAD, PALO ALTO, CA, 94304-1050, US

(21) Appl. No.: 12/212,635

(22) Filed: Sep. 17, 2008

Related U.S. Application Data
(60) Provisional application No. 60/973,154, filed on Sep. 17, 2007.
(60) Provisional application No. 60/987,006, filed on Nov. 9, 2007.

(51) Int. Cl. H04L 9/32; G06F 7/04

(52) U.S. Cl. 726/6; 726/7

(57) ABSTRACT

The invention provides methods and systems for management of image-based password accounts. A password management account may be accessed by a user undergoing image-based authentication. The invention may allow a user to manage parameters relating to image-based authentication. The invention may also allow a user to manage authentication at one or more web site.

### CROSS-REFERENCE

This application claims the benefit of U.S. Provisional Application No. 60/973,154 filed Sep. 17, 2007 and U.S. Provisional Application No. 60/987,006 filed Nov. 9, 2007, which applications are incorporated herein by reference in their entirety.

### BACKGROUND OF THE INVENTION

1. Field of the Invention

The invention is directed to methods and systems for management of image-based password accounts. In particular, the invention is directed to a password management account.

2. Background

Computer networks, particularly those with global reach such as the Internet, have greatly influenced the way that individuals, companies and institutions conduct transactions, and store and retrieve documents, images, music, and video. Convenience, ease of use, speed, and low overhead costs are contributing factors to the widespread use of the Internet for purchasing goods as well as conducting confidential transactions. Entire industries have emerged as a result of the evolution of the Internet.

Secure access to computer systems and computer networks has been traditionally guarded with a username and password pair. This requires the user to protect the username and password from unauthorized use. If the username and password are not protected, accounts and files can be compromised. Unfortunately, a number of rogue individuals and organizations have emerged that are dedicated to fraudulently obtaining confidential information for unauthorized or criminal activities.

A pervasive tool used in obtaining confidential information is keystroke-logging software, which constitutes a program that monitors and records what users type on their computers. Such software often comprises a payload of viruses, worms, Trojan horses, and other forms of malware. Keystroke-logging software can reveal what a user is typing on a computer without the user's knowledge of this event occurring.

Companies and institutions routinely use keystroke-logging software to monitor employee activity. Also, families may use these types of programs to monitor children's online activities. The widespread availability of this type of software, however, has led to unauthorized or criminal use, resulting in the alarming rate of identity theft seen throughout the world.

Prime targets for these attacks are financial institutions, as more and more consumers and businesses use electronic methods for purchasing and making payments. According to the American Banker's Association, cash and checks now account for only 45 percent of consumer's monthly payments, down from 57 percent in 2001, and 49 percent in 2003. The trend is clearly in favor of electronic transactions, providing a wider field for identity theft.

Login information may also be “heard” by sophisticated analysis of the distinct sounds made by different keys. An inexpensive microphone near a keyboard can reveal most of what is being typed with a surprising degree of accuracy (http://www.schneier.com/blog/archives/2005/09/snooping_on_tex.html). The invention thwarts attempts to record the successful completion to the login process, as the keystrokes typed cannot be linked to the user's true authentication parameters.

Login information is also vulnerable to simple spying or “shoulder-surfing,” as a person with malicious intent watches an unsuspecting user sign into his or her account. The invention employs a method that significantly reduces the likelihood of a successful shoulder-surfing style of attack.

Additional security mechanisms are necessary in addition to the username/password paradigm to provide stronger identity authentication. There have been various other attempts to do so.

Enterprises and institutions are using costly physical devices to identify legitimate customers and users. The existing devices generate a unique pass code for each user every 30 to 60 seconds. If an attacker manages to intercept a user ID and password, the information cannot be used to access the site without an additional authentication identifier displayed by the device. The devices significantly reduce instances of identity or information theft, but present challenges for both the institutions and individual users.

The enterprise may meet with consumer resistance in implementing use of the physical device. If the user does not have the device, he or she cannot gain access to the site. Besides the tremendous initial cost of purchasing the physical devices and implementing the new system, if the device is lost, stolen, or damaged, the enterprise will incur even more significant costs. In the context of business use of the device, the company incurs the cost of lost productivity from a worker who cannot access company information, as well as the cost of replacing the actual device. In the context of consumer use, if the consumer cannot access his or her accounts because of a lost device, the direct costs, and more significantly the indirect costs incurred by the enterprise to assist the consumer in gaining access far outweighs the advantages of using the device system.

In U.S. Pat. No. 5,559,961, Blonder provides a solution for utilizing graphical passwords. The framework described displays a static image in which the user touches predetermined areas of the screen, called “tap regions,” in a particular sequence. As the user taps various areas on the display, the regions tapped are successively removed from the screen. These regions of the screen, and the order of the sequence they are tapped, are chosen by the user during an initial enrollment phase. The sequence and regions of taps is stored in the system as the user's password. One shortcoming of this solution is the likelihood of a shoulder-surfing attack: once an attacker views a user entering the sequence by touching areas of the screen, he or she is then easily able to replicate the sequence to successfully gain access to the user's account.

U.S. Patent Application Publication No. 2003/0191947 to Stubblefield uses inkblots as images for authentication of a user's identity when logging into computer systems. The authentication method described in this patent provides for a display of a random sequence of inkblots that the user has identified when he or she enrolled his or her login information. One drawback to this process stems from the identification of the inkblot. Although the user is required to identify and verify the alphanumeric text associated with the inkblots in the enrollment process, the ineffable nature of inkblots will cause consumers problems in remembering the code for their inkblot selections. A frustrated user will simply save their password information on their computer, write the information down, or enter incorrect password information, which defeats the security offered by this system. Also, this process is very intimidating for users, especially those who are neophyte users, because the inkblot is easily misconstrued as a myriad of different objects. The inkblot is just that: a blot on a screen the user will associate with a real world object. If that user misinterprets or forgets the association they have made with the inkblot they are denied access to their system. More importantly, the sequence process significantly increases login time for users. Currently, users are demanding more secure login techniques, but they desire to maintain the same level of convenience that they currently enjoy with the username/password login process. This authentication technique does not provide the ease of use that consumers desire.

U.S. Patent Application Publication No. 2004/0230843 to Jansen, which is a login authentication process using a sequence of images selected by the user, illustrates the potential of image-based authentication in protecting users from identity theft. The authentication method described in this patent application begins with the user selecting an image theme, such as animals, and then selecting a sequence of images within the image theme that becomes the password (e.g. if the category chosen is animals, one possible sequence is horse, cat, dog, cat, cat, horse). The success of the login process is predicated on the user's ability to replicate the sequence of images he or she has chosen within the image theme. In other words, the user must memorize the proper sequence. One drawback appears to be the complex nature of the sequence process. As defined in the patent application, if a user feels that he or she will be unable to remember the password, the user will simply write down the password so that recall becomes unnecessary. Also, because the images are typically static (the user can elect to “shuffle” images between login attempts, but most will likely stay with the simple default configuration), software can be created to automate the process. In this scenario the authentication requires no human interaction to complete the login, which tremendously decreases the level of security provided. Although the positions of the images can be shuffled within the grid, the fact that they are static means that shuffling only prevents attackers from guessing the likely placement of the sequence, not the images themselves. Moreover, the traditional text password is completely removed from the login process, meaning that the security offered in this solution is only single layer, whereas authentication processes that complement the existing login process provide multiple levels of security.

U.S. Patent Application Publication No. 2005/0268100 and Publication No. 2005/0268101 to Gasparini et al. discloses two way authentication including images which serve as customization information so that an entity can authenticate itself to a user, but is otherwise dissimilar.

Such authentication methods may be relevant to situations where a user may have multiple accounts that require user authentication. Various accounts may have different authentication methods, some of which may have security concerns, such as those noted previously.

Because of these noted shortcomings, improved systems and methods are needed to manage one or more password accounts. A further need exists to manage an image-based password account.

### SUMMARY OF THE INVENTION

The invention provides methods and systems for image-based password account management. It is a further object and purpose of the invention to provide an image-based authentication and security system, which may require graphical discernment of one or more image categories. Various aspects of the invention described herein may be applied to any of the particular applications set forth below. The invention may be applied as a standalone password account management system or also as a component to an integrated authentication solution. The invention can be optionally integrated into existing business and authentication management processes seamlessly. It shall be understood that different aspects of the invention can be appreciated individually, collectively or in combination with each other.

An aspect of the invention provides a registration or enrollment mechanism and process for new or first-time users. During an enrollment stage, a user may provide user information and may select one or more image-based authentication parameter, such as a series of image categories, which may allow user authentication.

Another aspect of the invention provides password account management systems. An embodiment provided in accordance with this aspect of the invention may include image-based authentication systems and methods such as those included in U.S. patent application Ser. No. 11/420,061 filed May 24, 2006; U.S. Patent Publication No. 2007/0277224 filed Feb. 21, 2007; and U.S. patent application Ser. No. 12/035,377 filed Feb. 21, 2008, which are hereby incorporated by reference in their entirety. Such authentication systems and methods may have a user to input a login identifier. After validating the username, a graphical display with images corresponding to at least one pre-defined category may be displayed. For instance, one image from each category may appear at a random location within a grid of images. Each image may be overlaid with a randomly generated sequence of one or more image identifiers. Within the image grid, the user may identify the images corresponding to the pre-selected authentication categories, and input each associated image identifier in the provided input field.

In accordance with these and other embodiments of the invention described elsewhere herein, the identity of a user can be authenticated by matching the image identifier(s) input by the user with the correct image identifiers(s) derived from the pre-chosen authentication sequence. More preferable embodiments of the invention can be implemented in conjunction with a traditional identity authentication paradigm such as username/password as an extra layer of security, thereby increasing the security provided by the overall system.

Furthermore, various image-based authentication methods and systems may be used in conjunction with password management accounts, which may be used to manage image-based authentication systems or methods. A password management account may also include storing and managing one or more passwords associated with one or more web sites.

Another aspect of the invention provides methods for image-based password account management. Any of the apparatuses, systems and password management accounts described herein may be used to implement a method of password account management.

Another aspect of the invention provides systems and methods for sponsored authentication. The invention may also facilitate advertisement campaigns by displaying images, descriptions, and/or references supplied by or chosen by advertisers. Preferable embodiments of the invention provide a series of one or more graphical images displayed in a predetermined grid or other arrangement for viewing by the user.

Other goals and advantages of the invention will be further appreciated and understood when considered in conjunction with the following description and accompanying drawings. While the following description may contain specific details describing particular embodiments of the invention, this should not be construed as limitations to the scope of the invention but rather as an exemplification of preferable embodiments. For each aspect of the invention, many variations are possible as suggested herein that are known to those of ordinary skill in the art. A variety of changes and modifications can be made within the scope of the invention without departing from the spirit thereof.

### INCORPORATION BY REFERENCE

All publications and patent applications mentioned in this specification are herein incorporated by reference to the same extent as if each individual publication or patent application was specifically and individually indicated to be incorporated by reference.

### BRIEF DESCRIPTION OF THE DRAWINGS

The novel features of the invention are set forth with particularity in the appended claims. A better understanding of the features and advantages of the invention will be obtained by reference to the following detailed description that sets forth illustrative embodiments, in which the principles of the invention are utilized, and the accompanying drawings of which:

FIG. 1 shows a system with client computers interacting with a server over a network.

FIG. 2 illustrates a registration page to create a new password management account.

FIG. 3A illustrates a category selection step in a password management account registration process.

FIG. 3B illustrates a category selection step with categories selected.

FIG. 4A illustrates a practice step in a password management account registration process.

FIG. 4B illustrates practicing using image-based authentication.

FIG. 5 illustrates a step in a password management account registration process where a user tries signing in with image-based authentication.

FIG. 6 illustrates a step in a password management account registration process where a user may enter user information.

FIG. 7 shows a start page that may be displayed after a user has registered for a password management account.

FIG. 8 shows a home page for a password management account.

FIG. 9A shows a contacts page for a password management account.

FIG. 9B shows an example of a user interface to add new contacts.

FIG. 9C shows an example of a user interface to add contact information.

FIG. 10A shows an example of an image-based password parameter modification page for a password management system.

FIG. 10B shows an example of modifying a parameter of an image-based password.

FIG. 11 shows a privacy page for a password management system.

FIG. 12 shows an advanced settings page for a password management system.

FIG. 13A shows a user information page for a password management system.

FIG. 13B shows an example of a user interface that enables a user to add more information to the user information page.

FIG. 13C shows another user interface that may display a selected user profile.

FIG. 13D shows another user interface that displays a new user profile and allows a user to modify the profile.

FIG. 14A shows a password sites page that lists sites with remembered passwords.

FIG. 14B shows an example of a user interface to list remembered passwords.

FIG. 14C shows an example of a user interface to modify a remembered password.

FIG. 15 shows a list of sites with OpenID enabled for a password management account.

FIG. 16 shows a list of ignored passwords page of a password management account.

FIG. 17A shows a browsers page for a password management account.

FIG. 17B shows a list of activated browsers in a browsers page for a password management account.

FIG. 18 shows a list of account activity for a password management account.

FIG. 19 shows a notifications page for a password management account.

### DETAILED DESCRIPTION OF THE INVENTION

While preferable embodiments of the invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

The invention provides methods and systems for image-based password account management. One aspect of the invention provides a password management account for managing one or more password, where a user may access the password management account by undergoing an image-based authentication system or method. A preferable embodiment of the invention may include image-based authentication as provided in U.S. patent application Ser. No. 11/420,061 filed May 24, 2006; U.S. Patent Publication No. 2007/0277224 filed Feb. 21, 2007; and U.S. patent application Ser. No. 12/035,377 filed Feb. 21, 2008, which are hereby incorporated by reference in their entirety.

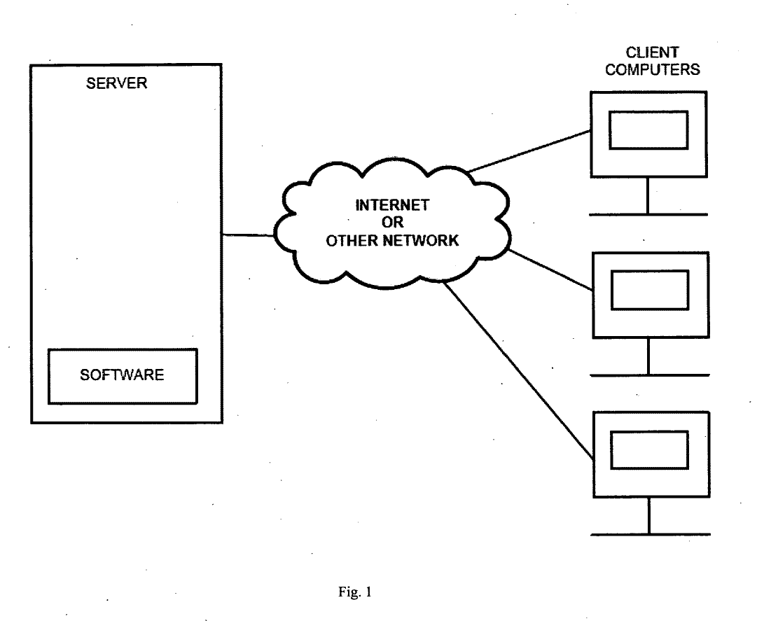

A user interface for a password management account, provided in accordance with one aspect of the invention herein, may be displayed across a network such as the Internet. For example, as shown in FIG. 1, one implementation of the invention may include a client computer or device communicating with a server over a network. The server (system) may control access to a resource, a database or file system, or a private communication channel. The server may also include a computer readable memory, a comparator and a communications interface such as a modem or network adapter with appropriate software drivers that support communication with the client system over a communications system. The server system may further include a secured network, file systems or resources and information stored in databases as described elsewhere herein. The databases may contain one or more libraries of graphical images or icons that can be displayed for authentication and other purposes (e.g., advertising). The server system may also include numerous devices such as file servers (web site servers), authentication servers, password databases, repositories or databases of graphical images or icons that may be identified as part of authenticating and non-authenticating categories.

A memory device in the server system may store information regarding the relationship between the graphical images, image identifiers, and any other image-based data that may be displayed to a user during authentication. A memory look-up table can be used to store this information for mapping this information. The memory may be implemented using random access memory (“RAM”), flash memory, disk drives or any other rewritable memory technology. In some applications, the memory may also be implemented using non-rewritable memory such as read only memory (“ROM”) chips.

The client system may include various devices such as a desktop or laptop computer, a PDA, an ATM, a mobile phone, or any device capable of displaying graphical images having a key entry pad or interface for entering data. A client system device preferably includes an input device, a display device and an appropriate communications interface which may allow data from the input device to be transmitted to the server system. The communications interface might include a modem, network adapter, radio transmitter/receiver, or other such communications devices, along with appropriate software.

A client input device may a computer keyboard, keypad, a touch screen, or other such entry system that allows input to be entered.

The display device may be any type of display capable of displaying various graphical images or icons. A visual display may include at least one display page for providing an interface with a password management account. Visual displays may include devices upon which information may be displayed in a manner perceptible to a user, such as, for example, a computer monitor, cathode ray tube, liquid crystal display, light emitting diode display, touchpad or touchscreen display, ATM screen, mobile telephone or device screen, and/or other means known in the art for emitting a visually perceptible output. Visual displays may be electronically connected to a client computer according to hardware and software known in the art.

In one implementation of the invention, a display page may include a computer file residing in memory which is transmitted from a server over a network to a client computer, which can store it in memory. Similarly, one or more servers may communicate with one or more client computers across a network, and may transmit computer files residing in memory, as discussed further below. At a client computer, the display page may be interpreted by software residing on a memory of the client computer, causing the computer file to be displayed on a video display in a manner perceivable by a user. The display pages described herein may be created using a software language known in the art such as, for example, the hypertext mark up language (“HTML”), the dynamic hypertext mark up language (“DHTML”), the extensible hypertext mark up language (“XHTML”), the extensible mark up language (“XML”), or another software language that may be used to create a computer file displayable on a video display in a manner perceivable by a user. Where network comprises the Internet, a display page may comprise a web page of a type known in the art.

A display page according to the invention may include embedded functions comprising software programs stored on a memory, such as, for example, VBScript routines, JScript routines, JavaScript routines, Java applets, ActiveX components, ASP.NET, AJAX, Flash applets, Silverlight applets, or AIR routines. A display page may comprise well known features of graphical user interface technology, such as, for example, frames, windows, scroll bars, buttons, tabs, drop-down menus, fields, icons, and hyperlinks, and well known features such as a point and click interface. A display page according to the invention also may incorporate multimedia features.

A display page may display content that may enable a user to interact with a password account management system. For example, a display page may comprise a web page that may enable a user to manage one or more password accounts. The web page may include various configurations or features to create or manage a password management account.

Furthermore, the client and server systems can communicate over a variety of telecommunication systems including wireless networks. The telecommunications system may also include a variety of data communications systems generally known in the art such as a local area network (“LAN”), a wide area network (“WAN”), a wireless system such as cellular, satellite and personal communications services (“PCS”) systems, or a dedicated line or connection. Access can be provided at a local node or other such client computer or device within the network, such as user personal computers. In this regard, it is noted that the references to server side and client side herein do not require a direct communication therebetween and intermediate computers may be present. Moreover, a computer acting as a server could transmit information to an intermediate computer which could then transmit the information to another computer where the user enters data. The terms “client” and “server” as used herein are general and are not limited to so-called “client/server” systems. It shall be further understood that references to a server and a client also may apply to a peer-to-peer system or architecture with any two communicating computers, where at least one such computer controls or possesses a resource, and another computer is used to access the resource.

In accordance with one aspect of the invention, a user may access a password management account by undergoing image-based authentication. For instance, a password management system may accept a login identifier such as a username or other identification (which may include alphanumeric characters). For an ATM or similar system, a login identifier may include a swipe card, biometric detector, or other device. A password management system may then authenticate the user upon entry of one or more appropriate password elements derived from an image-based authentication display. In some embodiments, image-based authentication may be used in conjunction with a traditional username/password authentication paradigm to increase the overall level of security in a system.

In some embodiments, image-based authentication may include generating a graphical display, such as an image grid, that may display images from different categories, including at least one preselected authentication category. The location of the categories in the graphical display may be randomized. The specific image for each category may be chosen randomly from a database of images for that specific category. Each image can be overlaid with a randomly generated image identifier.

The user may select or input the image identifiers (or password elements) corresponding to the images or icons selected within the arrangement. Selected image identifiers can then be communicated by the client system to the server system. The server system can compare the user selected image identifiers relative to a reference password, and further analyze related information with any other associated authentication data that may be stored in a memory within the server system. Upon the correct entry of the one or more image identifiers, which matches the reference password, authentication of the user can be completed.

The server system may utilize a comparator to compare the selected image identifiers with reference password information as described elsewhere herein. The comparator in the server system can compare the one or more image identifiers entered by the user to reference password information to determine whether they correspond to each other and match. If so, the user may be allowed appropriate access to the server system. It shall be understood that the comparator, and other components to the aforementioned client/server systems implemented in any of the authentication systems and methods herein, may incorporate software using techniques known in the prior art. Furthermore, it shall be understood that any of the components and their uses are not limited to the embodiments described, and may be implemented by any system and architecture known in the art, including peer to peer systems.

In accordance with another aspect of the invention, methods and systems further provide user management of image-based password accounts. For example, a user may access a password management account on a web site (e.g., myVidoop.com) through an authentication process. Upon authentication of the user, various aspects concerning the very same authentication process and related parameters can be managed and modified to provide user defined levels of security. Furthermore, various aspects concerning authentication processes for other remote systems may be managed and modified as well.

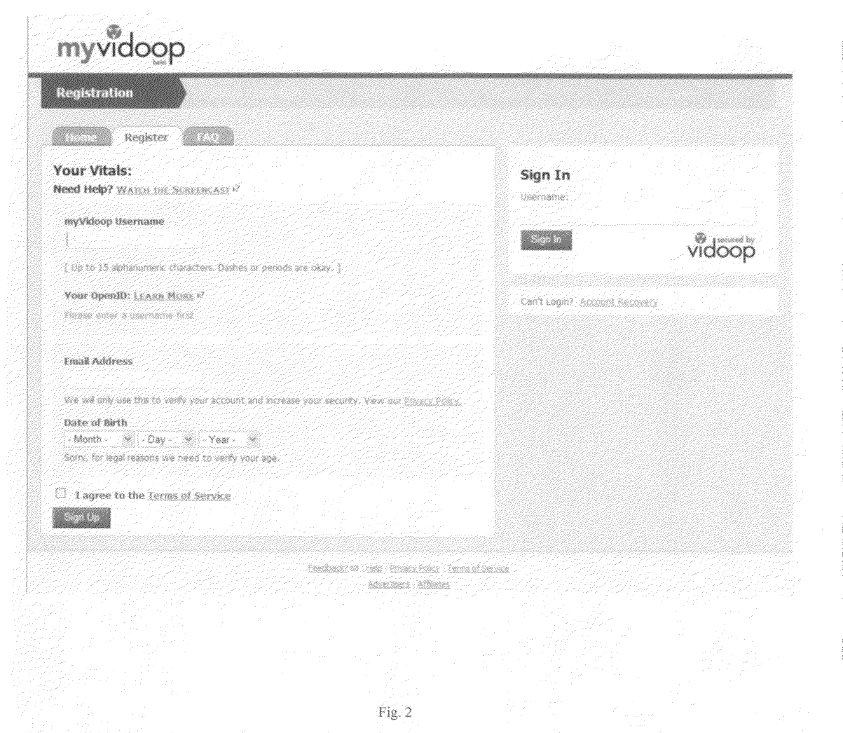

One aspect of the invention provides a registration or enrollment mechanism and process for an image-based password management account. FIG. 2 illustrates a registration page to create a new password management account. During an enrollment and registration process, a user may open an account to manage passwords and authentication processes. In some embodiments of the invention, an enrollment and registration process may include multiple steps. For example, a registration process may include a user navigating through a registration page, a category selection page, a practice page, a sign-in page, and a final steps page. The number of pages or steps may vary. For example, in another registration process, there may be one page where a user may enter user information as well as image-based authentication parameters. A registration process may or may not include a step to practice signing in with an image-based authentication system. In some cases, registration steps may have a fixed order while in other cases the order may be flexible.

FIG. 2 provides one example of a step in a registration process. A user may select a login identifier. A login identifier may be a username which may be preferably unique to that individual. The registration page may provide an interface such that when the user enters a username, the interface will display whether the username is available. In some cases, the interface may display whether the username is available while the user is typing or selecting the username. In other cases, the interface may display whether the username is available after the user submits the username. In some instances, the user may also provide an email address that can facilitate enrollment initially. A confirmation email can be sent to the user email account with specific login instructions, including a link that can guide the user through enrollment, in order to confirm that the user provided a valid email address. In some instances a confirmation email may include a confirmation code that may be entered at some point in the enrollment process.

In some embodiments, additional information may be entered, such as a user's birth date or an agreement to terms of service. The user may be allowed to click on a link and continue with enrollment within a predetermined period of time before being timed out. In some cases, the user may be allowed to proceed by clicking on a button to submit information or by clicking on a tab that may take a user to the step visually mapped to the tab. In some implementations, a user may only proceed to the next step if a prior step has been completed, while in other implementations, a user may directly access a next step without completing a prior step.

A registration page may also provide a user interface for a user with a pre-existing password management account to login.

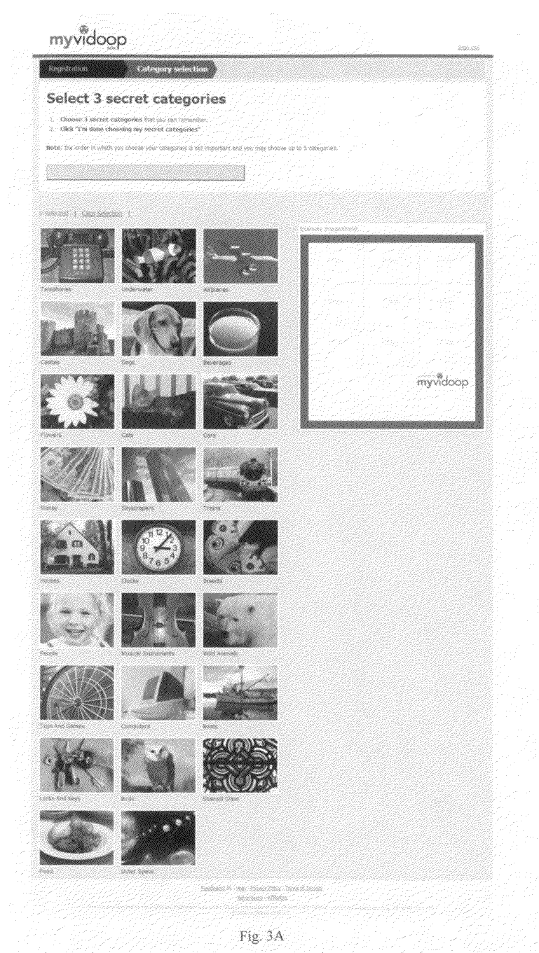

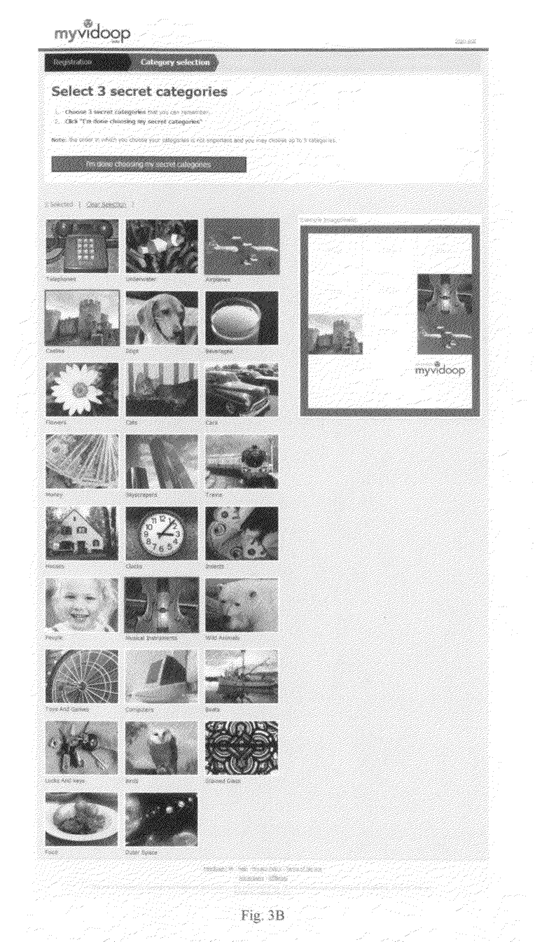

FIG. 3A illustrates a category selection step in a password management account registration process. A user may proceed with selecting parameters for image-based authentication. For example, a user may select single or multiple authenticating categories. Authenticating categories may include objects, topics, themes, or characteristics. For instance, categories may include objects (such as telephones, airplanes, cars), themes (such as underwater or outer space), or characteristics (such as objects that are red, objects that start with the letter ‘B’, or the number of objects). A user may select an authenticating category by selecting a category from a list, by viewing image-based examples of authenticating categories and selecting an exemplary image, by having the password account management system randomly select categories for the user, or by any other ways of selecting an authenticating category.

In some embodiments, a fixed number of authenticating categories may be selected. Alternatively, a user may select any number of authenticating categories and then indicate when the user has completed selecting authenticating categories. In another embodiment, a user may select a number of categories within a range (i.e., a user may select between three to five categories) and may indicate when the user has completed selecting categories. If a user has not selected a number of categories that falls within a range or fixed number, a user may not be able to proceed until the user has selected an acceptable number of categories.

FIG. 3B shows an example of a category page where categories have been selected. For instance, when a user has selected a category, a visual indicator may indicate to a user that the category has been selected. For instance, a category may be highlighted or may have a border, or another indicator such as a shape or symbol may be visually mapped to the category. The category selection page may include a running total of the number of categories selected. The category selection page may also indicate a range or number of categories that may be selected. Additionally, selection indicators may include numbers that display the order in which the categories were selected. In some cases, an additional visual indicator, such as an exemplary graphical display may be used to display the selected categories. For instance, FIG. 3B shows a grid with exemplary images from selected categories displayed. Another example of such an additional visual indicator may be a running list on the side, naming the selected categories.

An enrollment process may allow a user to select other image-based parameters. For instance, a user may select how an authentication display may appear, a desired security level, a confirmation color, or any other image-based parameters.

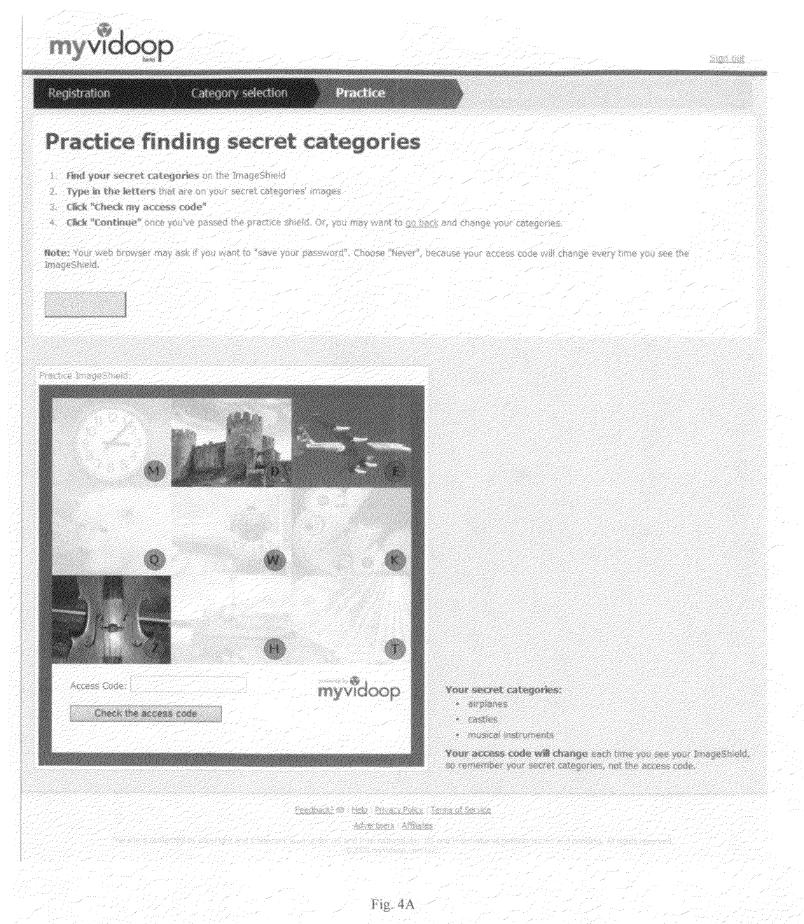

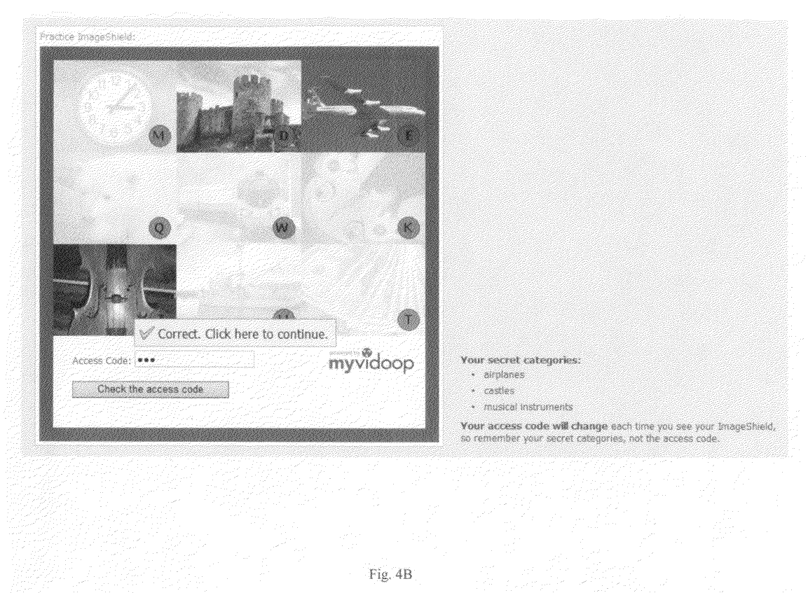

FIG. 4A illustrates a practice step in a password management account registration process. A practice page may include an image-based authentication display with specified image-based authentication parameters. For example, the image-based authentication display may include a grid of images. Showing specified image-based authentication parameters may include displaying authenticating image categories within the grid. The practice authentication display may or may not be the same or similar to how authentication display may appear during an actual authentication process. For instance, during an actual authentication process, the authentication display may comprise a 4×4 grid, while during a practice, a 3×3 grid may be displayed. Displayed images may include an access code component. In a practice step, authenticating image categories may be visually differentiated from non-authenticating image categories. For instance, authenticating image categories may be displayed with normal resolution while non-authenticating image categories may be phased or faded out. Furthermore, a list of selected authenticating image categories may be provided. An area may exist for a user to enter an access code.

FIG. 4B illustrates a step of practicing using image-based authentication. For instance, a user may enter access code components corresponding with authenticating image categories. An interface may be provided to submit the access code components. After a user practices using image-based authentication, the practice page may confirm whether a user was successful in the user's authentication attempt. Such a step may verify user recognition of an authenticating category. Depending on the image-based authentication system and parameters specified, a practice step may be implemented in any number of ways in order to enable a user to practice using image-based authentication.

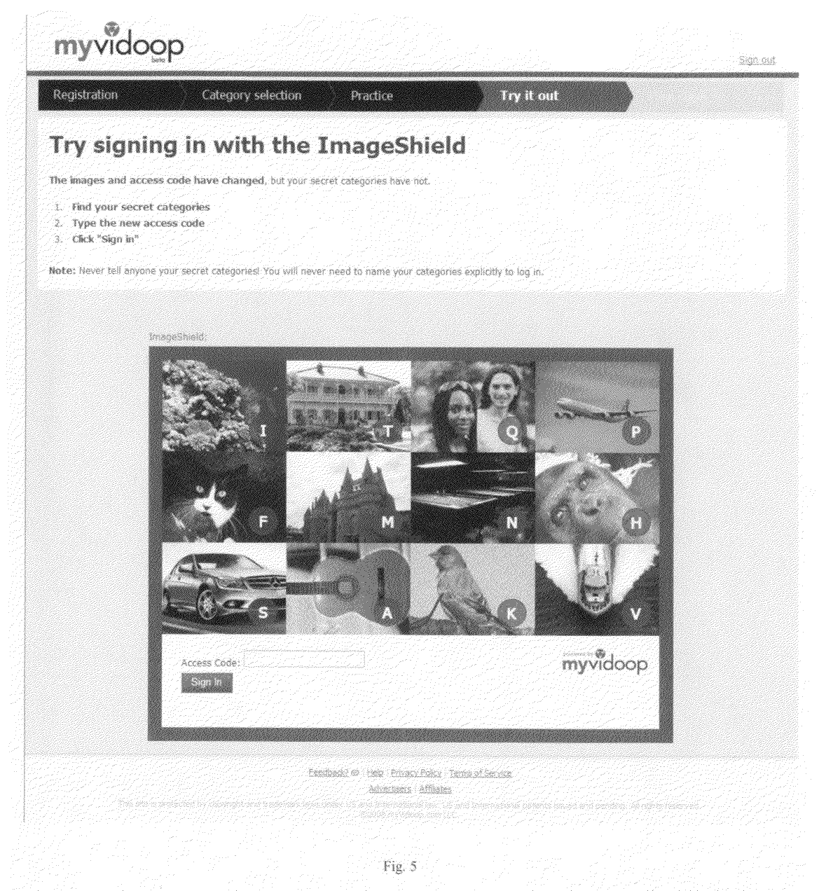

FIG. 5 illustrates a step in a password management account registration process where a user tries signing in with image-based authentication. A sign-in page may include an image-based authentication display as could be presented to a user during a usual image-based authentication process. For instance, an authentication display may be a 3×4 grid. In other embodiments, an authentication display may include any graphical arrangement or configuration of images. This may enable the user to practice using the image-based authentication system, although the display may be different from the previous practice step.

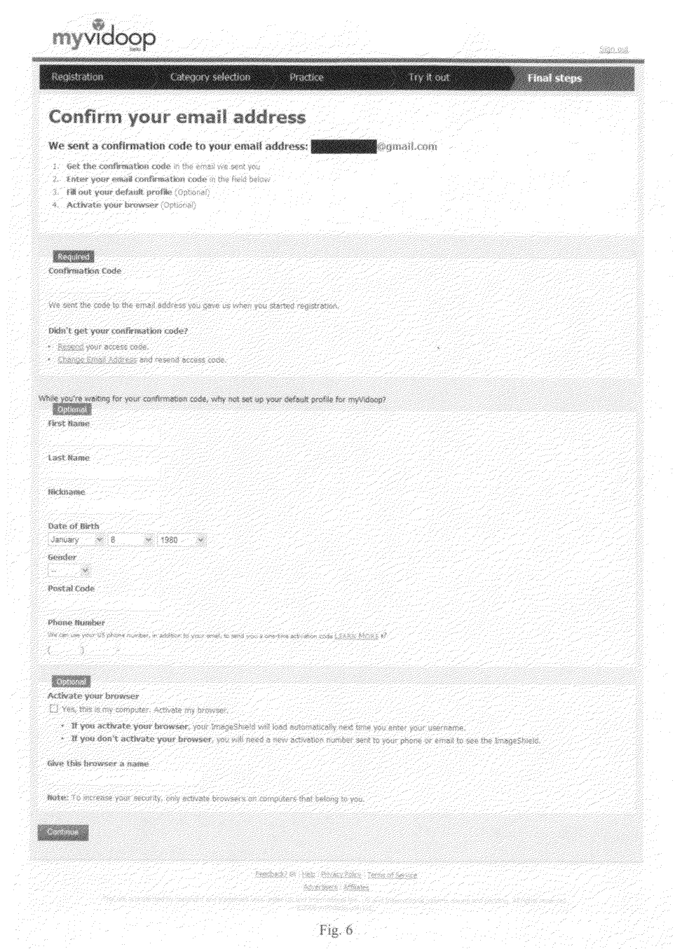

FIG. 6 illustrates a step in a password management account registration process where a user may enter additional user information. In some cases, various parts of the information may be required while various items of information may be optional. For example, a user may be required to enter a confirmation code that may have been sent to the user's email account, as discussed previously. Other examples of information that may be included are the user's name, nickname, birth date, gender, address, phone number, and so forth. A user may also be able to activate the user's browser, which may be preferable if the user is on the user's computer. A user may be able to complete an enrollment process when a user submits the user's information.

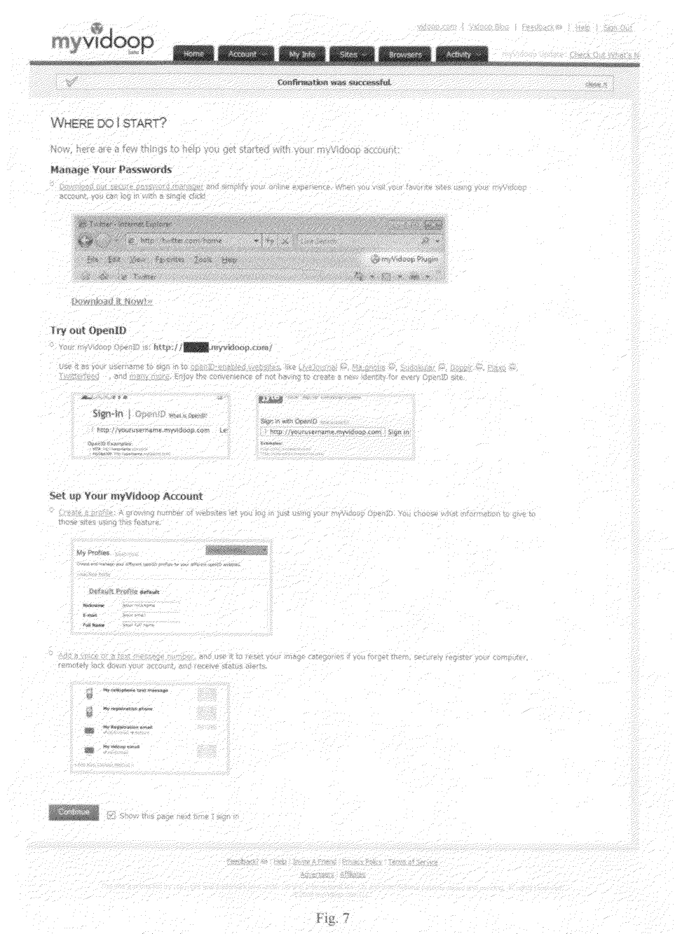

Another aspect of the invention provides a password management account that may be used in systems and methods of image-based password account management. FIG. 7 shows a start page that may be displayed after a user has registered for a password management account. In some cases, a start page may appear after a user has first registered for the password management account, while in other cases, the start page may appear whenever a user logs into the user's password management account. A start page may include any sort of information that may be useful to a user starting to use the password management account. For example, the start page may highlight features available to the account. For instance, a user may download a password manager which may simplify using the account. A start page may include access to various plug-in or gadget features that a user may download or enable to facilitate use of the account. For instance, plug-in features that may assist with managing password accounts may be discussed in greater detail below. The start page may also include ways for a user to set up interfacing with other web sites or devices, such as providing interfaces with other web sites that may enable a user to login with the password management account identification, or allowing a user to interface using telephones, PDAs, or other mobile devices. Links may be provided to enable a user to directly access parts of the password management account that may involve features presented on the start page.

The password account management systems may include a user interface that provides information and access to different available resources. The interface for the password management account may include one or more pages that may enable user interaction with the password account management system. These pages may have any arrangement or configuration that may enable a user to interact with the system and are not limited to the embodiments discussed. Various pages with various content items may be included.

For instance, a user may navigate from one page to another by way of tabs or nested tabs. For example, a web site for a password management account may include tabs for home, account, user info, sites, browsers, and activity. The account tab may include nested tabs for contacts, password parameter settings, privacy, and advanced; the sites tab may include nested tabs for password sites, ignored sites, and trusted sites; and the activity tab may include nested tabs for account activity and notifications. The pages can be organized differently; for instance, there may be tabs for home, sites, user info, and accounts, such that each of these tabs may include nested tabs with various pages for the password management account. Other navigational features known in the art including lists, drop-down menus, links, buttons, and so forth may be used.

A user interface may also include account information that may be visible to a user regardless of which page of the web site the user is on. For instance, a user interface may include an area (such as on the side, top, bottom) displaying basic information about the user account, such as username, the user's OpenID, and current browser. Other information, such as a summary of recent activity for the password management account, or the most recent account activity may be visible. Such information may also include links that may direct a user to a relevant page of the password management account.

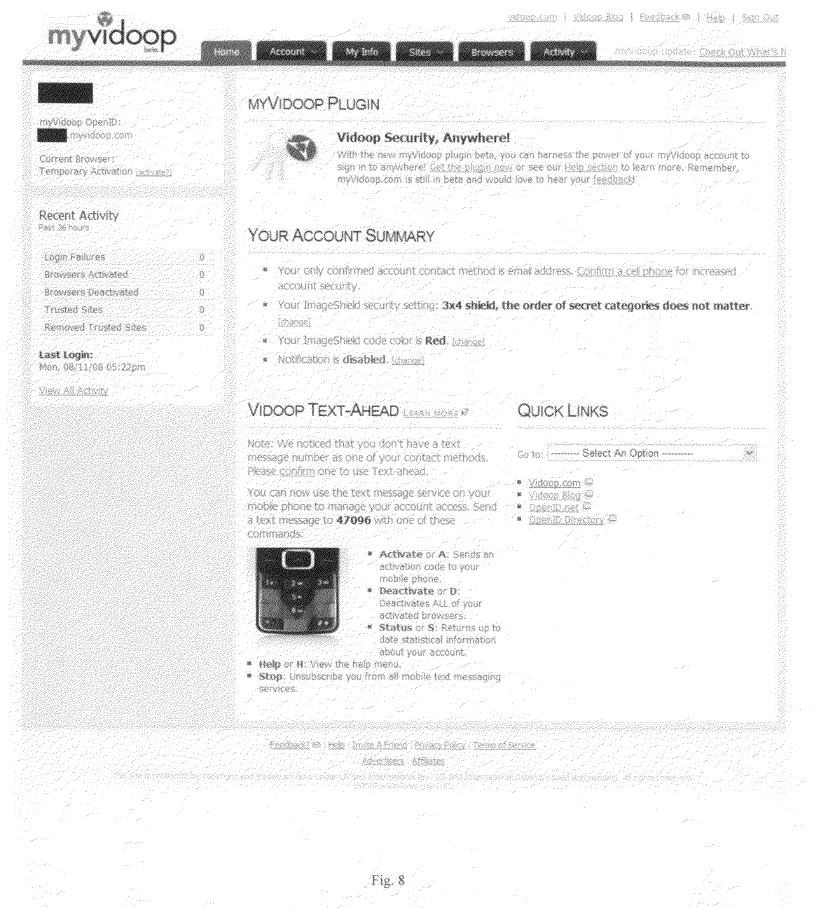

FIG. 8 shows a home page for a password management account. A home page may provide a variety of account information including an account summary which may describes current account and user defined settings, plus special or highlighted features such as text messaging functions to manage the account remotely (to be discussed further below). Such account information may also include links that may allow a user to directly access a relevant page of the password management account. A home page may also enable a user to access various parts of the password account quickly. For instance, a quick links section may enable a user to select a page from a drop down menu, or to click on a link to favorite links. The quick links may be defined by the password account or by the user. For example, the quick links may be adjusted based on which sites the user visits most often or frequently.

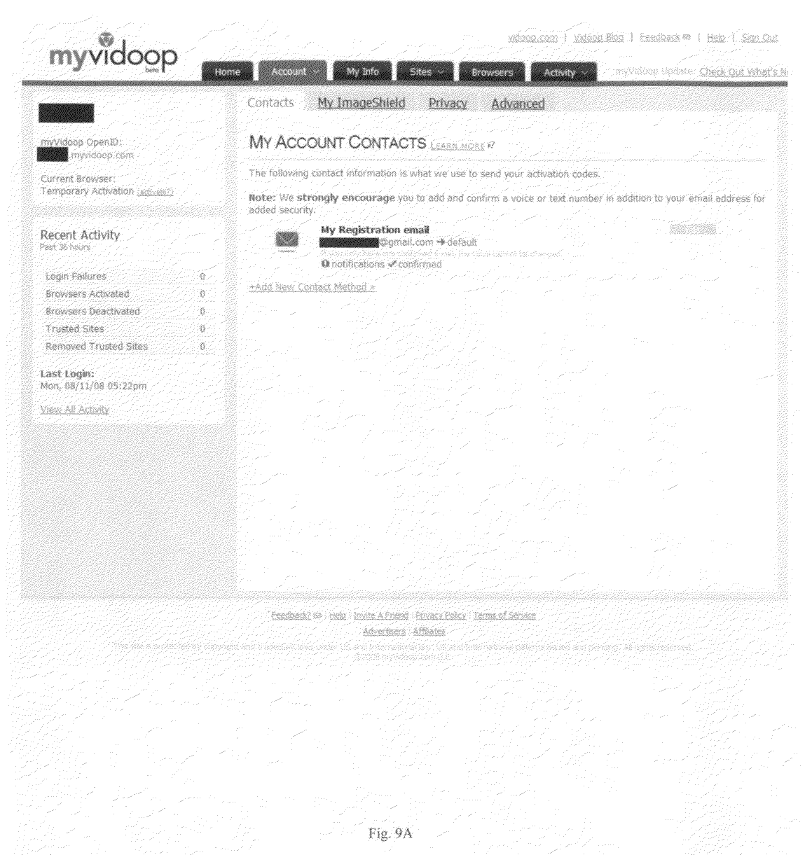

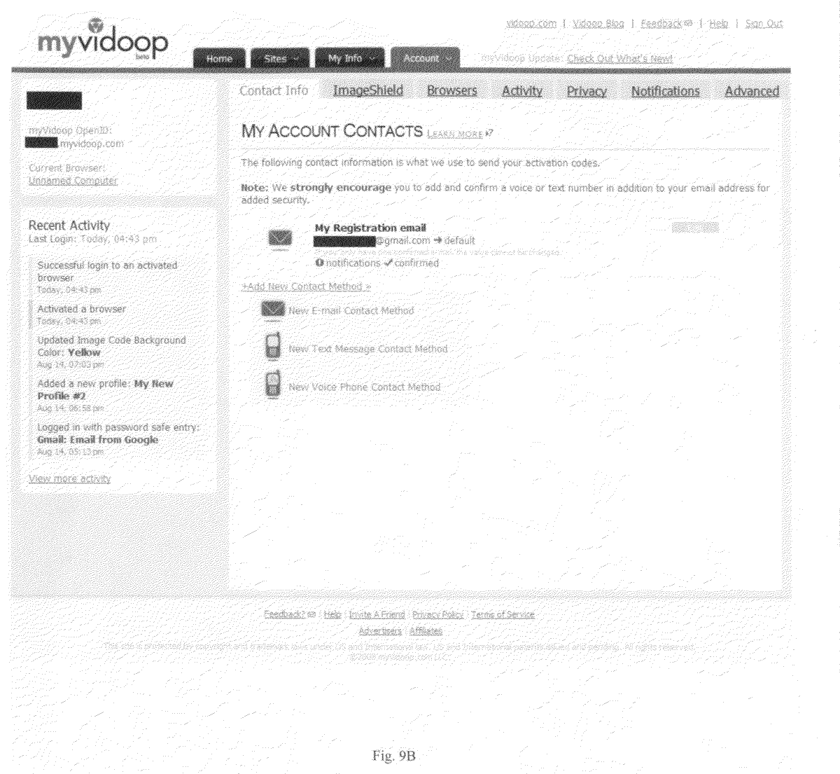

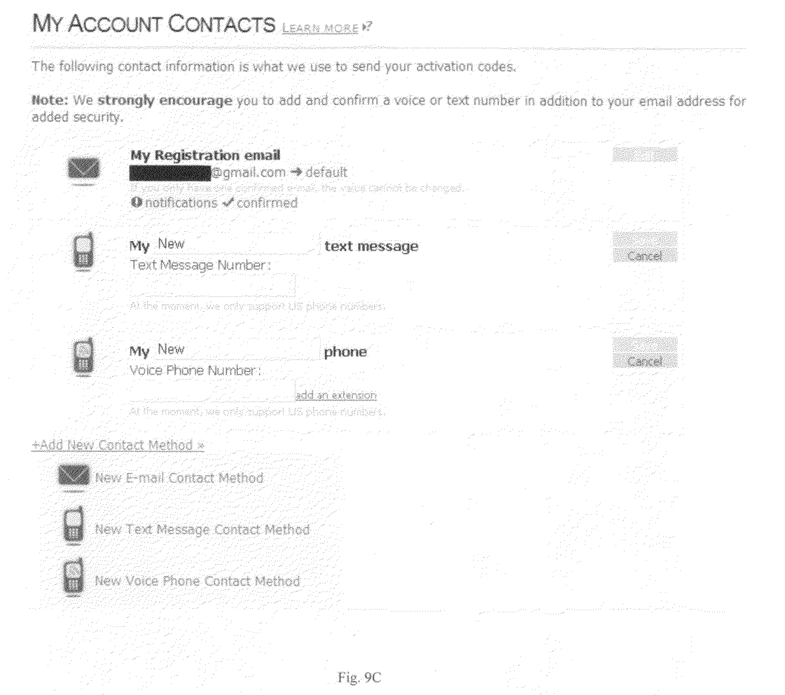

FIG. 9A shows a contacts page for a password management account. An account section or tab can provide user contact and password related information. The user may navigate to a contacts page or tab which may be under the accounts section, which may allow a user to view and enter contact information. User contact information may include one or more email addresses associated with the user, one or more telephone numbers to support voice communications, text message numbers belonging to the user, and/or any other user or device contact information. Contacts may be displayed to identify the different routes in which activation codes and other information can be delivered to users. Various contact channels with external devices, such as text messaging, are to be discussed in greater detail below.

FIG. 9B shows an example of a user interface when a user chooses to add a new contact method. Selecting an option to add a new contact method may display different ways a user may be contacted. FIG. 9C shows an example of a user interface when a user selects one or more contact method to add. For instance, a user may device to add a new text message and new voice phone contact method. A user may choose a name for the contact method and include any relevant contact info. Some or much of this information may be obtained during an enrollment or registration process. For instance, a user may enter an email address and phone number during registration. These contacts may be automatically stored and displayed under account contacts.

The contact information may relate to communications channels to the user that is are independent of online activity in order to provide added security. In addition, many features of the password management systems provided herein can be accessed over channels to external devices listed within the contacts page such as a text message phone number (see text ahead discussion and previous discussion). For example, information such as activation codes for image grids or displays can be delivered through out-of-band (OOB) contact channels or methods. As part of a two-factor authentication approach provided herein, embodiments of the invention call for both knowledge of activations codes and evidence of control over contact methods or channels/devices. Telephone numbers (voice, text) provided during registration can be added as a contact method for password accounts. Preferably, another contact method besides email may be utilized and can be used for various features including account recovery.

For example, if/when users forget their selected authenticating categories, recovery information (account recovery PIN or number) may be transmitted over activated communication channels listed among their contacts such as an email, voice call, or text message. In some cases, information may be transmitted to all activated channels, which may be beneficial in situations where a user may only have access to one of the channels at a given moment.

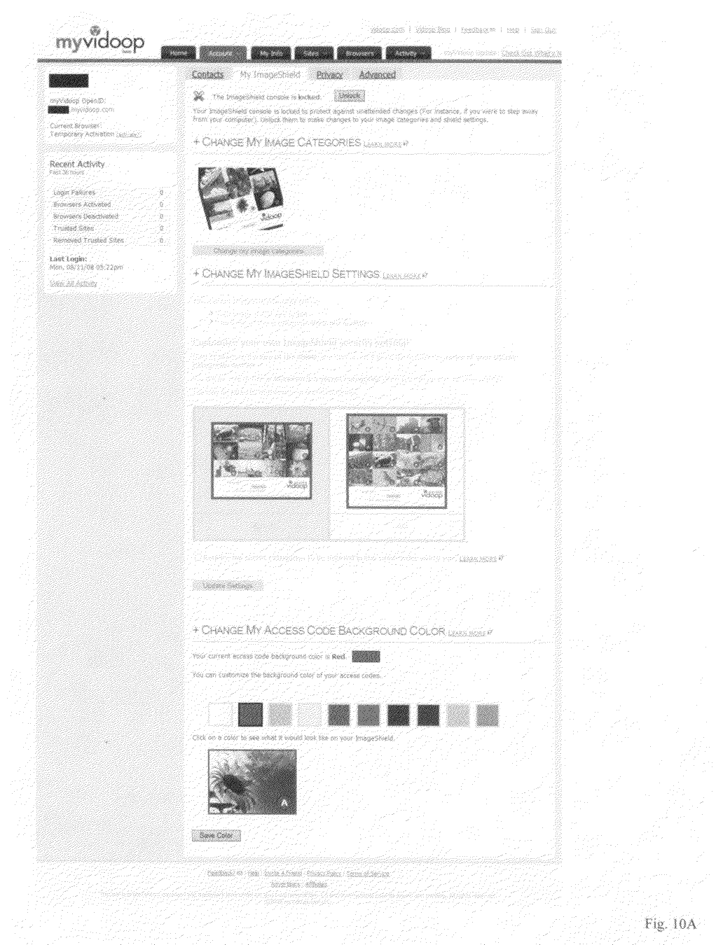

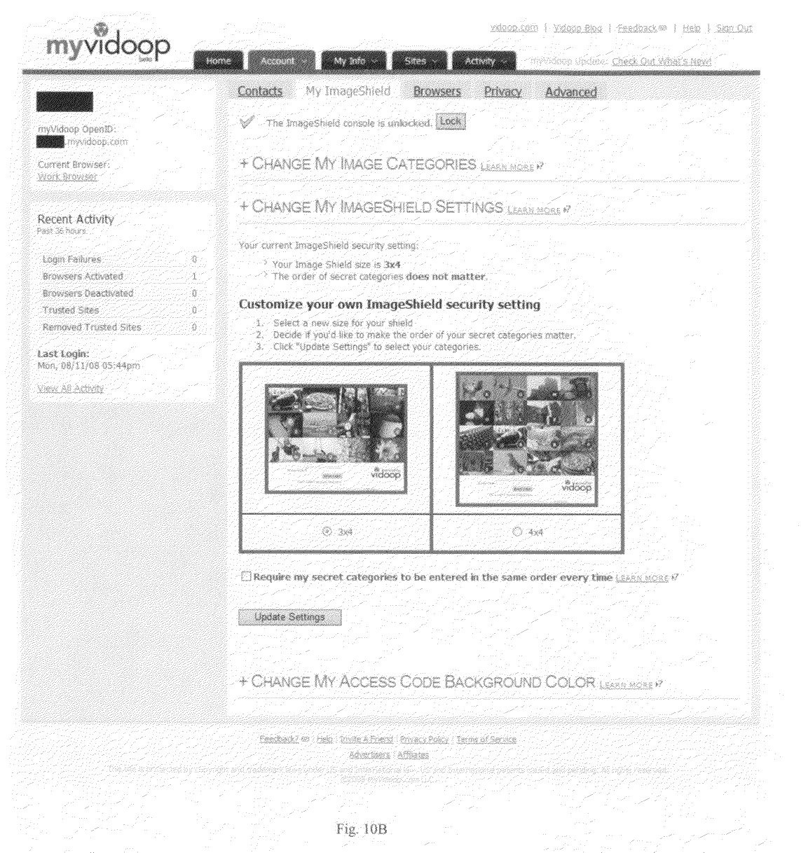

FIG. 10A shows an image-based password parameter modification section for an account page for a password management system. A password parameter modification page or tab may be also provided to allow a user to select or change an image-based password parameter. In some embodiments, a password may be locked, which may prevent a user from modifying any of the password parameters unless the user unlocks the password. This may help prevent a user from changing a password parameter by accident. In some instances, an interface may provide a list of password parameters or categories of password parameters that may be modified, such as a collapsed list that may enable a user to drill down to access the options to change the password parameters.

In one implementation, changing such a password parameter may include changing one or more image categories. In some embodiments of the invention, the initial image categories may be selected during the registration process. In other embodiments of the invention, the image categories may be initially selected and modified after the user has registered with a password management system.

Selecting image categories within a password parameter modification section may include viewing multiple authenticating categories that can be selected from a console or menu of displayed themes or categories (airplanes, money, insects, wild animals, etc.) each containing associated graphical images or advertisements as described previously. A blank or empty example image grid may be displayed which may be filled out upon selection by the user of authenticating categories. For example, the user may select three categories such as money, food and underwater. In some embodiments, a practice page may be presented to the user wherein a single image falling within each of the authenticating categories is displayed along with a corresponding letter, number or any other access code portion or image identifier. Other images from non-authenticating categories may fill-out the remainder of the image grid. An alternative embodiment of the invention may allow the user to select non-authenticating or other categories within the displayed category bundle, which may provide customization or a more personalized image grid.

Similarly, after a user has selected authenticating categories, a user may choose to modify the authenticating categories. In some embodiments, selecting an option to modify categories may refer a user to an interface that is similar to the interface for initially selecting categories. For instance, the categories may be listed or displayed with images. A user may select a number of categories that may be fixed or varied and indicate when the user has finished. As a user selects a category, a visual indicator may indicate selected categories. In some cases, the interface may visually indicate which categories the user has currently chosen and allow a user to unselect a selected category or add to the existing categories. In some embodiments, a user may practice authentication with the newly modified categories.

An additional way for a user to modify an image-based password parameter is to vary which authenticating categories may be displayed. For instance, if a user selects five authenticating categories, a user may select an option such that the five authenticating categories are displayed every time. Alternatively, the user may select an option that only three of the five authenticating categories may be displayed at any login. In some embodiments, a user may vary the number of images displayed per category. For instance, a user may select one category (i.e., things that are blue), and an authentication display may show three images from that category (i.e. a blue sky, a blue car, and a blue Smurf).

A user may also modify an image-based password parameter by customizing how the images will be displayed. For instance, a user may customize an image grid by choosing all categories (e.g., 12 for a 3×4 or 4×3 grid) to be displayed during each authentication process. In other instances, users may only choose authenticating categories. The image grids may draw the eyes or attention of users to images from their own personalized authenticating categories to deliver one-time access codes just in time for login. Because a different arrangement of pictures within the image grid may be presented while attempting to change/modify authenticating categories or between sessions with different access code portions, the complete one-time access code may preferably change every time a grid is rendered during authentication to provide a new graphical based dynamic password each time. The authenticating categories however may remain the same until changed so that users do not have to remember passwords.

An image grid may be customized by varying the dimensions of a user grid. For instance, a user may select the dimensions of a user grid. FIG. 10B shows an example of how grid dimensions may be selected. For example, a 3×4 grid and a 4×4 grid may be presented to a user, and the user may select one of the options. Any number of grids with any m×n dimensions may be presented to a user where m and n are positive integers where at least one of m or n is greater than one. In some instances, an interface may be provided that may enable a user to enter in the desired dimensions for an image grid. An authenticating display may also have other configurations which a user may select.

An image grid may also be customized by determining whether the order of authenticating categories entered matters or not. For instance, if a user selects cars, food, and houses as the authenticating categories, the user may select whether they have to enter the access codes corresponding to each of those categories in the order of those categories, or whether the order does not matter. A user interface may provide a check box to allow a user to indicate whether the order matters or not. Any variation on the notion of order mattering may be implemented. For instance, a user may indicate that the user may enter the access codes in ascending order based on the access code value, based on position (i.e. top to bottom, left to right) and so forth.

In addition, the password modification page can allow the user to set desired security levels. Such security levels may be defined to incorporate any image-based password parameter. In some cases, a security level may function as a set of pre-defined image-based password parameters, while in other cases, a user may choose to modify each of the image-based password parameters individually. Any number of security levels may be offered to a user.

In one example, three security levels may be established and offered to a user: Secure, More Secure and Most Secure. The Secure level may allow the user to select three authenticating categories, not require entry of access code portions in a specific sequence (entry of “123” will authenticate when reference access code is “321”), and offer a display of images within a 3×4 grid size. Generally, a relatively higher level of security can be provided when increasing the number of or using more authenticating categories, a larger visual grid and/or requiring entry of access code portions in a particular sequence (sequencing is enabled). A More Secure level may therefore require the user to enter the access code portions in a particular sequence (entry of “123” will not authenticate when reference access code is “321”). A Most Secure level may further require in a 4×4 grid of graphical images thereby making it even hard to guess or observe the three, four or more authenticating categories selected by a user when entering an access code. Any of these or other levels may be established or modified as with other category related changes, preferably upon execution of an authentication process itself, in order to provide user defined security levels.

Furthermore, a user may select a background color for the dynamic image grids herein and/or the displayed image code or identifier alongside each of the images therein, which may be another image-based password parameter. For example, an image code color such as “red” may be selected as a default parameter and changeable to other selectable colors as desired. A sample image plus superimposed image code within a color circle or border can be displayed during a selection process to provide a preview to the user. So whenever a user is presented an authentication grid, the user may observe the selected image code color. Otherwise the user may suspect some kind of fraudulent activity (e.g., phishing) suggesting the web site being accessed may be an unauthorized or fake site.

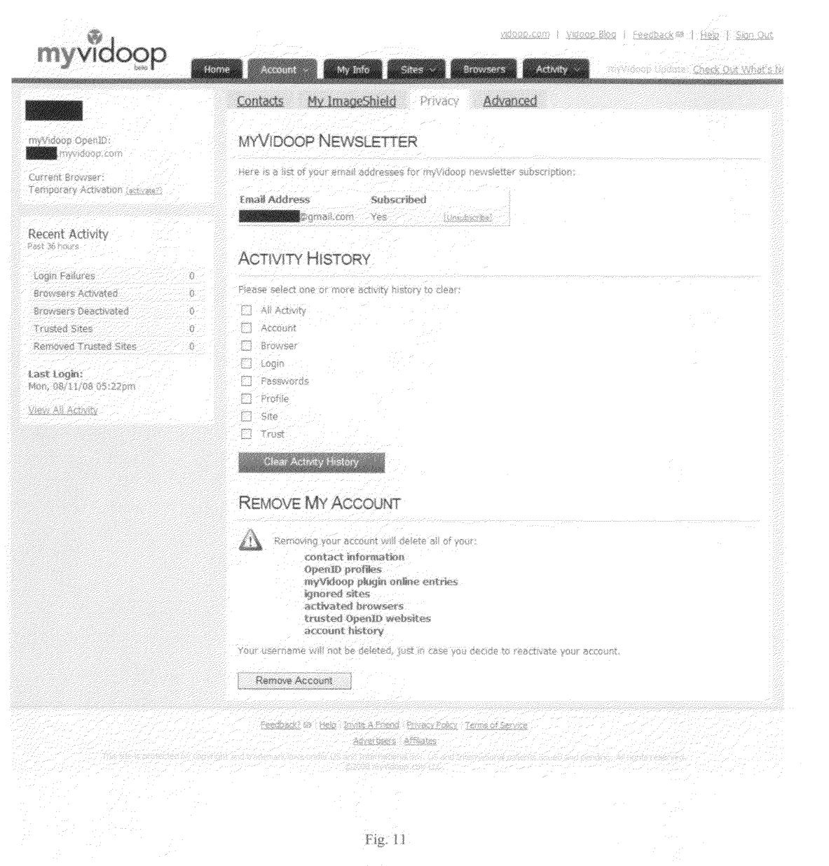

FIG. 11 shows a privacy page for a password management system. A privacy page may enable a user to remove items from a user's password management account. For example, a user may select items from a user's activity history to clear. A user may select an activity history category (to be discussed in further detail below) or may choose to clear all of a user's activity history. A user may also decide to remove a user's account. Removing an account may delete a user's contact information, OpenID profiles, plug-in online entries, ignored sites, activated browsers, trusted OpenID web sites, and account history. In some cases, removing an account may keep the username in case the user decides to reactivate the account at a later time. In some embodiments, a user may reset a user account, which may remove some information, but allow a user to keep certain, basic items, such as personal information.

A privacy page may also include other features, such as a list of email addresses or other contact methods that are included for a newsletter subscription from the password account management system.

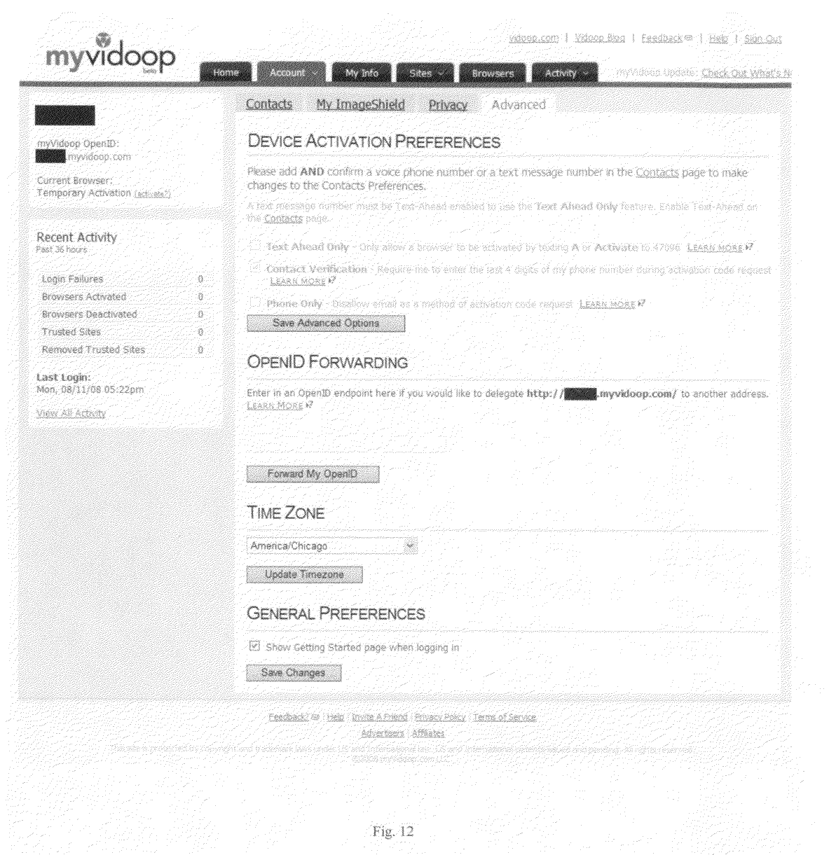

FIG. 12 shows an advanced settings section for an account page for a password management system. An advanced page or tab may be provided to offer additional functions and features to the user relating to the password account. A variety of general preferences may be displayed on the advanced page including whether to automatically present a start page to users upon login (as discussed previously). This feature may provide useful tips or reminders to users to perform certain activity to augment security or otherwise improve user experience. In addition, a series of device activation preferences may be offered to the user when attempting to activate a device on which authentication processes provided herein can be performed.

For example, it may be possible that someone other than the user obtains a username for password account and may attempt to instruct an activation code to be sent to a device such as a mobile telephone number. Before the activation is sent out to a phone number contact that has been registered, confirmation may be requested such as the last four (4) digits of the device number before the activation code is delivered. As with other optional security features provided herein, this may be turned on/off by a user. Furthermore, another optional embodiment of the invention enables a user to select account preferences whereby device activation codes can only be received only over select or secure channels such as either confirmed voice phone numbers or confirmed text message numbers (hardware only). Email addresses will therefore not appear as an option or possible activation code delivery method within a drop down box according to this embodiment. When used in conjunction with the “last 4 digit verification” feature described above, this may prevent someone other than the user from sending activation codes to certain contact methods.

Another embodiment of the invention provides text messaging capabilities for the password management systems herein. A short messaging service (SMS) may be selected to facilitate the sending and receiving of short messages to and from a mobile phone or device. For example, text messaging over a text message interface may allow users to manage password accounts through text messages from a mobile phone or device. Users can text commands and/or receive text confirmations or replies indicating success or providing account information. Various text message commands may be defined for text messaging including read-only and imperative commands. Read-only commands may include those which provide information through a test reply and do not modify password account settings. Imperative commands may affect user accounts and may therefore require confirmation that the messages originated from a user since they may be spoofed.

A protocol may be adopted to control how imperative commands are carried out including but not limited to the following: (1) User texts a command to short code with a registered mobile device; (2) Short code replies with a one-time confirmation code; (3) User replies with confirmation code; and (4) Action is executed and the result is forward to the user. While such protocols may increase user burden, it may generally decrease the chance of executing commands that did not originate from an authorized device or user. Meanwhile, various kinds of text message confirmations can be sent to users. Such confirmation may consist of predefined code sent to verify user identity and ordinarily will not contain commands or command key words or letters.

After a user has added and confirmed a text message number as a contact method or communication channel, a text ahead feature may be implemented in accordance with a preferable embodiment of the invention. A text message may be sent to a short code or number (e.g., 47096) in combination with a series of one letter or one word commands as the body of the text message including but not limited to the following: Activate or A: Sends a device activation code to a mobile phone or another device over an out-of-band (OOB) medium so an image grid can be rendered from a device that has not yet been activated; Deactivate or D: Deactivates or invalidates all of a user's activated devices which may require performing activation procedures again; Status or S: Returns up to date statistical information about a user account including log statistics such as number of failed logins for a day and activity (see Activity page); Help or H: View the help menu by providing a list of commands when no request specified or offering help on a specific command when provided; Stop: Unsubscribe user from all mobile text messaging services which stops text messaging services such as OOB authentication codes or receive notifications (see notifications page), and removes the mobile device or number as a contact (see contacts page).

Other one-letter commands may be offered which could also have one or multiple aliases including but not limited to the following: “C” or “Code” to allow an end user to request an OOB one time activation code (and preferably received with user instructions to take action in the event such information or code was not requested); “G” or “Group” or “Grp” which can send a SMS message to each member of a specified group within the password authentication system and/or individuals with different password accounts; “R” or “Remove” to remove or unsubscribe a user from a specified group, which may require a confirmation or authentication mechanism also; “L” or “Lock” and “U” or “Unlock” to lock and unlock password accounts or devices (and preferably received with user instructions to restore accounts or devices to unlocked state); “Activity” or “Actvty” to provide users with certain account events such as the time and results (failed/successful) login attempts, which may be limited by system or user defined parameters in the number of text characters that may be sent or received by a user device, preferably activated beforehand; “Sites” or “I” to provider users with a list of URL's or web sites that are trusted sites; “Devices” or “Devcs” to provide users with a list or the names of some or all registered devices for a password account. Command messages that are neither related to a predefined or recognized command or confirmation may be logged for later reference (or added as specific user defined commands that are customized for the particular user(s)) and/or discarded by the password management systems herein.

This text ahead feature may be enabled or disabled according to user preference. When this feature is enabled, the user may already have an activation code in hand when logging in on an unactivated computer. An optional pop-up box and/or link may be displayed in a user interface such as “I already have my activation code” whereby the user can click on the link to input the activation code sent when the user texted-ahead. When enabling this feature, it may be preferable that the only way to receive a device activation code is through the mobile phone being used by the user. A variety of other commands to monitor and protect a password account may be sent by a user to the short code or number associated with the password account systems herein via text messaging, include a variety of password management functions including deactivating devices, locking out an account, displaying activities or providing an activity log (see account activity page), displaying trusted sites, in addition to receiving activation codes. For example, a lock-down procedure may be ordered via text messaging (Lock) by a user for various situations such as a possible security breach with a user password account or activated device, or when a user away from a computer for an extended period of time for vacation or traveling. This can be a temporary precaution to disable some or all registered devices that can be reversed by delivering another text message command or counter-command (Unlock) to unlock an account and/or re-enable devices. The lock-down and unlocking processes provided in accordance with this embodiment of the invention may be characterized similarly to activating/deactivating an alarm system for a home when left unattended. Alternatively, one or more devices can be deactivated upon user command via text message thereby requiring a user to re-activate them before they can be used for authentication processes herein. The lock-down or deactivation procedures herein may be implemented via short messages on a device-by-device basis or global (all devices) basis.

It shall be understood that the password and account management systems provided in accordance with this aspect of the invention may include computer systems and servers with memory to execute a variety of computer applications. Computer software programs which provide the aforementioned text ahead features and text commands may further operate with various application programming interfaces (API) to two way communications with user devices such as messages sent to and from applications and end user mobile devices via a SMS or short code.

An advanced page may also enable OpenID forwarding. A user may select another OpenID address to forward the password management account OpenID address to. OpenID forwarding may enable a user to maintain control and consistency of the user's identity even when if identity providers may change. For instance, if a user has a password management account OpenID (i.e., username.website.com), but later wants to host the user's own OpenID provider or change to a new OpenID provider, the user can continue to use the password management account OpenID as the user's identity by setting it up as a delegate on the user's new OpenID provider. OpenID to be discussed further.

An advanced page may also enable a user to specify additional information. For instance, a user may specify the user's time zone.

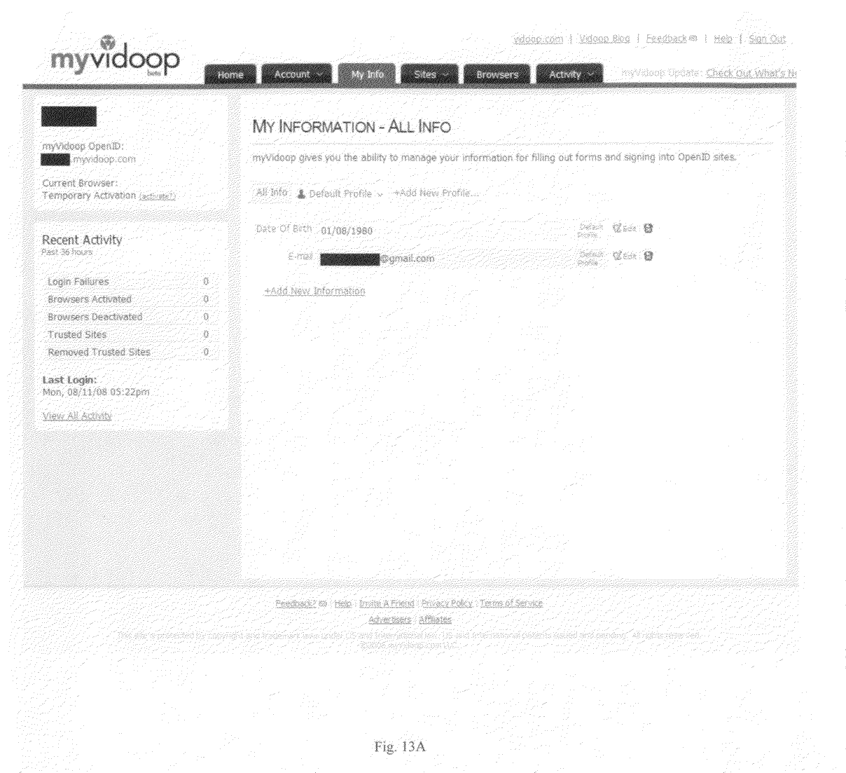

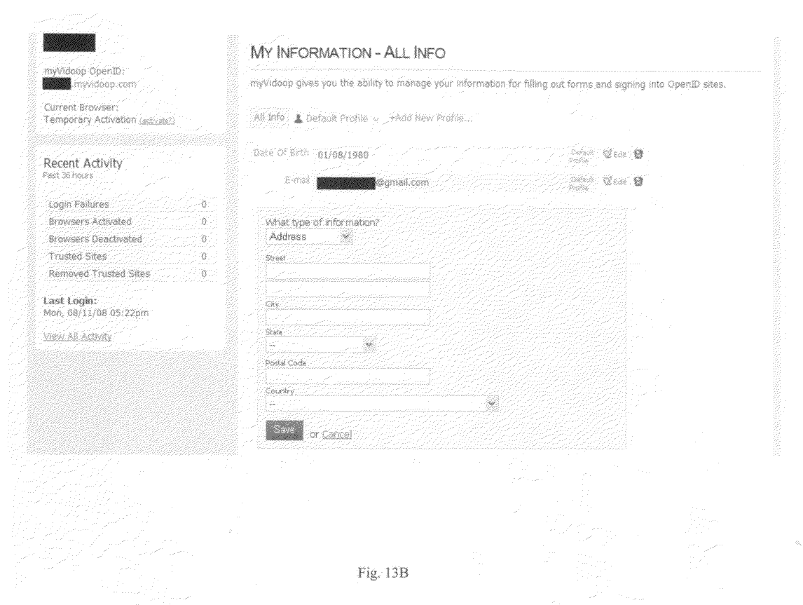

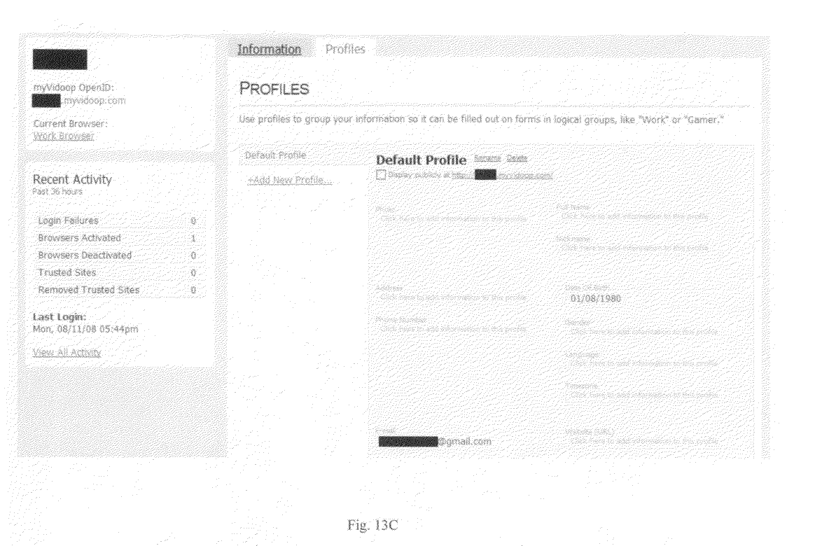

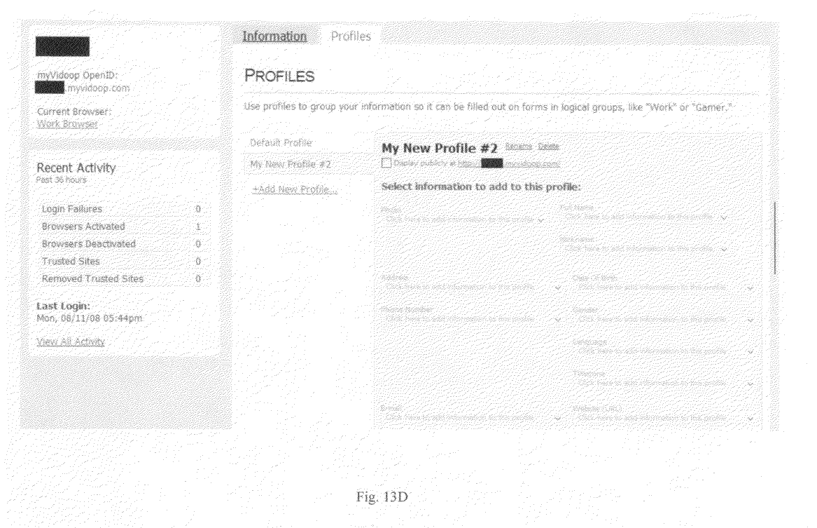

FIG. 13A shows a user information page for a password management system. A user information page may include user information to facilitate authentication at various web sites. For example, profiles can be created and managed according to particular OpenID enabled web sites so that users can avoid having to fill out different registrations forms calling for similar information each time such sites are visited. Such form data may be stored in a password management account and may be retrieved and transmitted in response to a given event. Such a given event may include a request by a remote site for password information or for other form data.

When signing into an OpenID-enabled site, a user can optionally choose to have password information transmitted that would otherwise need to be entered manually on the web site itself as part of a registration process. User profiles may contain the information that the password management system provided herein can store and send to these sites. Such information may include name (full or nickname) and email address(es), date of birth (i.e., MM-DD-YYYY), gender, postal code, country, language, and current time zone. The regular time zone in which the user resides or ordinarily authenticates may be also selected and included as part of account information. OpenID is an example of a single sign-on solution for the World Wide Web based in part on a single identity that can be used at various sites where OpenID credentials are accepted. More and more web sites are accepting or migrating to the OpenID standard every day including many blog sites, social networking sites and e-commerce sites. The password management systems herein may be configured to operate with the OpenID protocol in order to provide easier and more secure OpenID logins.

The convenience of a single sign-on standard is attractive to users and avoids having to maintain different identities at various web sites and remembering a different username and password at each site. Furthermore, an effective single sign-on standard may provide greater security than the security provided by the authentication systems at some of the web sites. Yet there is skepticism and fear among users in trusting a single identity solution due to the increasing ease with which passwords can be stolen. The password management systems and authentication systems provided in accordance with the invention may address these concerns by providing improved or better login security. As with other embodiments of the system that do not support the OpenID system, this alternative design may secure usernames against prevalent forms of hacking including keystroke logging, phishing, password guessing, and many Internet spying schemes.

Preferable embodiments of the invention support single sign-on capabilities on OpenID sites which are designated as or become relying parties. When allowing users to login to a web site using OpenID, a relying party site may accept an OpenID username (i.e., username.myvidoop.com) from the user who is logging in. The site could pass the user to an OpenID identity provider for authentication. The identity provider could then require the user to authenticate and subsequently pass the user back to the site being authenticated. Web sites may be prepared ahead of time so their computer systems may be configured to accept OpenID credentials. Moreover, OpenID does not rely on a centralized web site to confirm digital identity (decentralized) so that any web site can employ OpenID software as a way for users to sign in. When accessing OpenID enabled sites, users do not need to remember traditional authentication tokens such as usernames and passwords. Instead, users are previously registered on a web site with an OpenID “identity provider” or an i-broker. Accordingly, with respect to this embodiment of the invention, OpenID identities may be protected by the authentication processes described herein and used as a single sign-on for sites accepting the OpenID standard. Furthermore, other user profile information may also be transferred to sites accepting OpenID, which may allow users to skip entering certain user profile items at the other sites.

A user information page may manage the profiles for OpenID identity by providing an interface that may enable a user to manage user profiles. For instance, a user may have a default profile that may include information about the user, such as the user's email address or birth date, provided by user when the user registered for the password management account. A user may add more information to the user's profile. In one example, as shown in FIG. 13B, a user may select an option to add more information, which may display additional user interactive interfaces where the user can enter more information.

A user may also create additional profiles. In accordance with one embodiment of the invention, a user interface may display a default profile including various fields that a user may have entered data for, as shown in FIG. 13C. For instance, such fields may include a user's full name, nickname, photo, address, phone number, birth date, gender, language, time zone, web site, etc. If a user has not entered data for a particular field, a user may enter any desired data at the user interface. A user may select on the option to add a new profile, which may display a second profile with the various fields, as shown in FIG. 13D. Tabs or other visual indicators may be provided which are visually mapped to the current profile being viewed. For instance, the current profile and the name of the current profile may be highlighted.

In some embodiments of the invention, the password management system may support other sign-in standards, shared authentication schemes, or ways of sharing information with other web sites. Such standards may be used in the place of or in addition to OpenID.

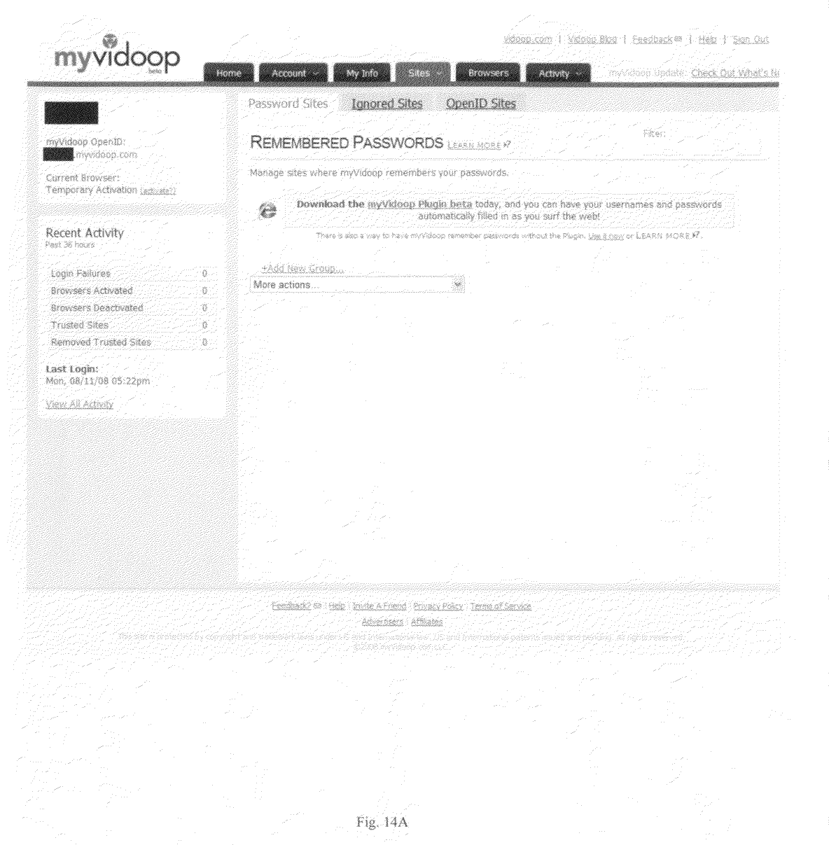

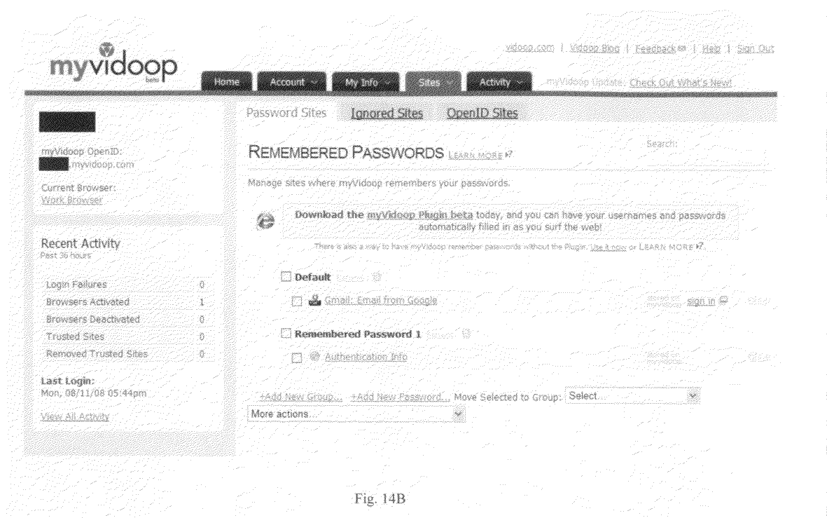

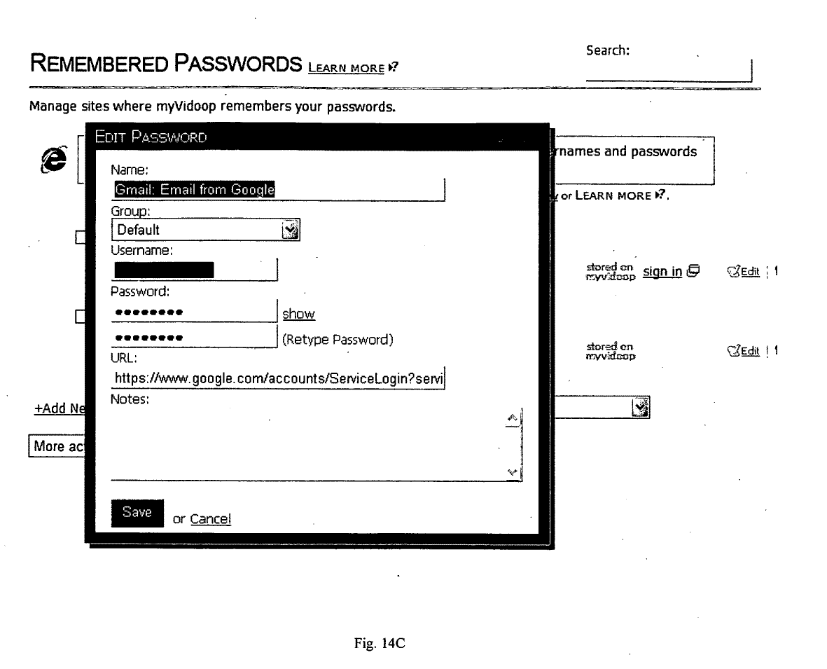

FIG. 14A shows a password sites page that lists sites with remembered passwords. A sites page or section can be provided to list and manage password information delivered to certain web sites through the password management systems provided herein. As part of the password management systems herein, plug-ins may be delivered to user devices to automatically fill in usernames, password information, and other form data.

Generally, a web form on a web site allows a user to enter data that is usually sent to a server for processing. A user may use a form to submit data to a server (e.g. saving personal information such as user street or email address), or to retrieve data (e.g. entering key words into the field of a search engine). Usernames and passwords entered on a web page can be form data. When such information is entered into the field of the form, it may be stored on a server in a database. Several web browsers, such as Microsoft Explorer or Mozilla Firefox, have form-filling processes or plug-ins that store and allow the user to manage personal data. These plug-ins may automatically fill in forms when the browser is being used. When using a browser auto-fill feature in accordance with the invention, user personal information may also be stored on the computer instead of a server.

Often, passwords may be stored in a cryptographically protected form by undergoing a process to store and access the information. For instance, when a user enters a password, the system may “hash” the password by using an algorithm to turn it into a relatively small value that serves as a digital fingerprint to the password. The word “password” might become something like 12ABCD34. For another layer of security, the system may “salt” the password before hashing it, by appending a predetermined string of characters that is stored in a database. If the salt in this case were “xyz1,” salting the password would make it “xyz1password,” which could then subsequently be hashed, giving it a different value, such as A12E99CD. If the user were to enter the password during another login, the same process would be used, and the hashed value would be compared to the hashed password already stored in the database.

The password information for various web sites can be entered and stored within the systems herein and transmitted during authentication processes at the appropriate time by way of a downloadable plug-in as provided in accordance with an aspect of the invention. For example, the first time a user visits a web site or enters a OpenID username (see user information page), the password management system may prompt the user whether the site is to be trusted sometimes (single session only), trusted always (trusted sites), not trusted, or never trusted with personal information.

If the user chooses to trust the site, then the system can send or display only the information selected by the user to execute a smoother and less time consuming login process. In some embodiments, the system may differentiate between sites with remembered passwords and OpenID sites. For example, FIG. 14A shows a passwords sites page with remembered passwords. A password sites page may store authentication information for a user at one or more sites. A user may access the authentication information through a user interface.

In some embodiments, one or more passwords may be retrieved in response to a given event. For example, some remote web site links may only display the authentication information to the user when the user selects the site. In other examples, the authentication information for some of the remote sites may be stored and the user may login to the remote site with a single click; a user may be directed to the remote site and authentication information may automatically be entered so the user can access the remote site immediately. For example, if the remote site is an online bank account, a user may click on a link for the bank account web site, and be automatically transferred and logged in, so that the next thing the user may view is the bank account information.

FIG. 14B provides an example of how a list of remembered passwords may be displayed. Remembered passwords for various remote web sites may be organized into groups. A user may manage and organize various remembered passwords so that they may be visually mapped within groupings or categories. FIG. 14C provides an example of how a user may edit the remembered password. A user interface for password editing may display fields, such as password name, password group, username, password, URL, notes, and any other relevant fields.

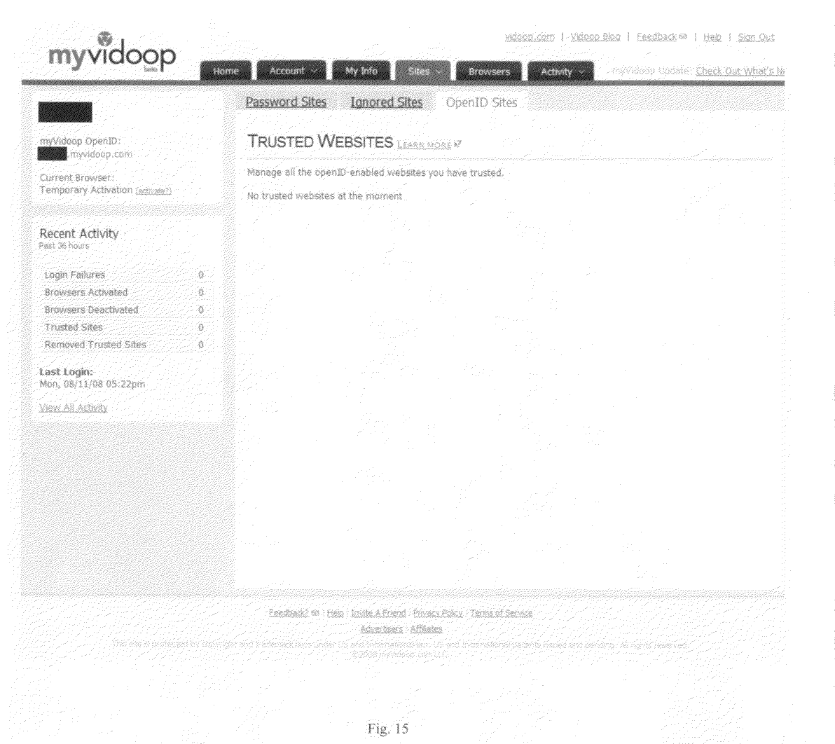

FIG. 15 shows a trusted web sites page. A trusted web sites page may list remote web sites that are always trusted for OpenID (or in some embodiments, for any shared authentication scheme or single sign-on system). For such trusted sites, a user can optionally choose to have the password management account transmit information that the user would otherwise have to enter on the web site as a registration process, such as name, email, address, phone number, birth date, etc. A trusted web sites page may enable a user to manage trusted web sites in a manner similar to managing remembered password web sites.

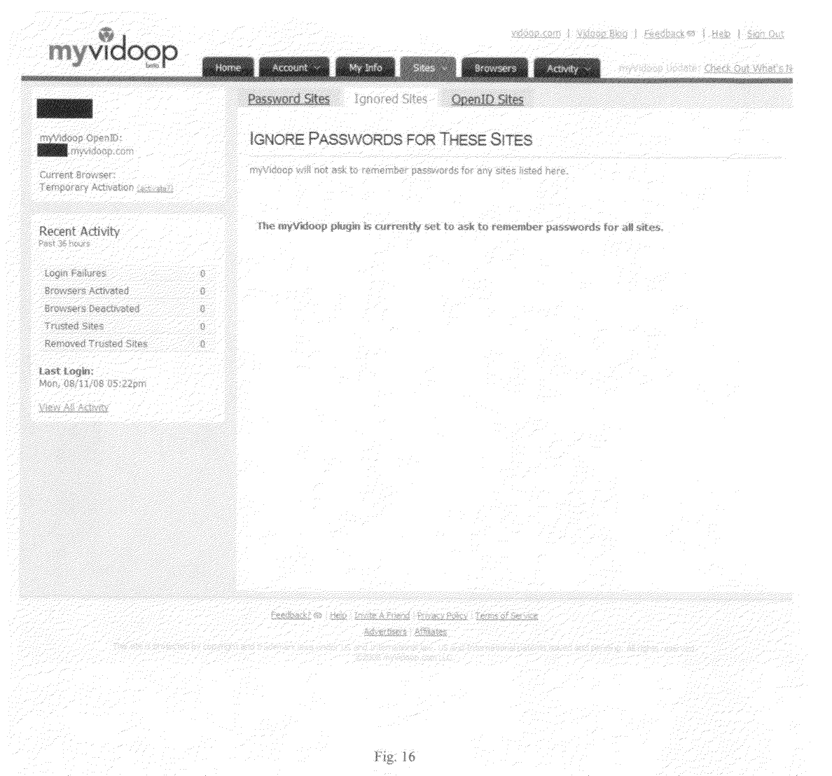

If the user chooses to never trust the site, then the hostname of the site may be added to a blacklist, which could live on the password management system server, and can be managed under an ignored sites page, as shown in FIG. 16. When a user signs into the password management system, the blacklist may be provided or downloaded and used to determine whether to ask to remember passwords for a web site. When a user is on an activated computer and not logged into the password management system, a plug-in may used to determine whether the site is on the blacklist. The plug-in may do this by following a protected process such as receiving the hostname, salting the hostname with a value only accessible to activated computers, hashing the salted hostname, and comparing it with the blacklist. The blacklist may provide convenience for a user who may not wish to store passwords for particular sites for reasons such as company policy or unsupported sites.

As discussed previously, a plug-in may be utilized by the password account management system to facilitate managing access to remote web sites.

Warm mode. When a user is operating an activated computer that has installed a downloadable plug-in as mentioned above and opens a browser without logging into the password management account (a so-called “warm mode”), the plug-in may inform the user that it knows how to fill in a form at a particular web site. When the user opens a browser, the plug-in may make a server request for a user salt (e.g. the predetermined string of characters or value), which may be retrieved if the computer is activated. When the user visits a web site that has a form with a password field, the plug-in may hash the hostname of the web site along with the user salt. The plug-in can search through a list of hashed hostnames that may be aggregated from a local file and an online safe. If there is a matching hash, the plug-in may know that it can fill the form and may inform the user, at which point the user can choose whether to sign in to the password management account to fill the form. This plug-in feature may provide convenience to a user while maintaining the security of his or her passwords, whether they are stored locally on the computer or on the password account management system server. Even if a hacker manages to obtain the hashed hostnames, the hacker could have a difficult time determining which sites have associated passwords.

Sign in anywhere. When a user is operating a computer with a plug-in as provided herein, the plug-in may save form metadata about the names and values of a form for each password the user saves. Form metadata may include data about information saved, such as the form's submitted name/value pairs and the submit action URL. So when a user saves a password on a web site with the plug-in, the plug-in may save form metadata, along with the username and password for this web site, on the password management system server. If the user later goes to another computer that lacks the installed plug-in, the user can still access the saved information by signing into the password management system and going to the password sites page. The user can there find the saved password entry and click a “sign in” button to be successfully authenticated by the web site. This ability to access information without a plug-in may increase the usability of the password management system for a user who may not be able to install the plug-in for various reasons, such as using an unsupported browser, using a computer belonging to someone else, and so forth.

Add anywhere. When a user is operating a computer that lacks a plug-in, the user may still add a password from that computer if using a supported browser, and the password can be filled by the plug-in at a later time or can be accessed without the plug-in, as previously described. When a user signs into the password management system, the user may choose to add a bookmarklet to his or her bookmarks. A bookmarklet is a small application, that when selected, may be run on the current site. The user may go to a web site with a password field, and click the bookmarklet, which could indicate that it found the form and change the submit action on the web site to submit any subsequently entered information to the password management system. When the user enters a username and password and clicks to sign in, the user may be redirected to the password management system and asked if he or she wants to add the password to his or her online remembered passwords. The user may choose yes or no, and then may be directed back to the original web site and authenticated. The use of this bookmarklet feature may increase the usability of the password management system for a user when the user does not have access to the plug-in.

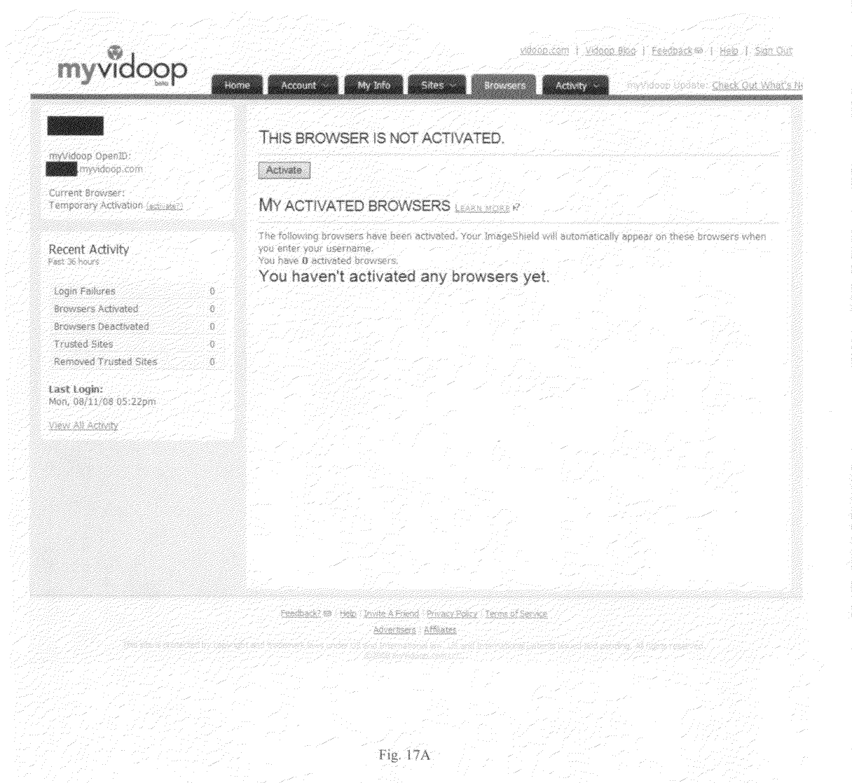

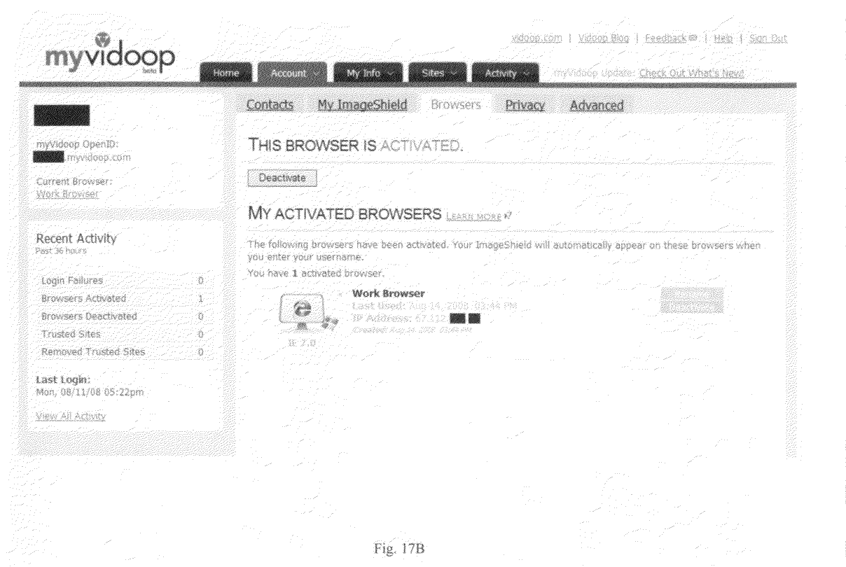

FIG. 17A shows a browsers page for a password management account. A browsers page may identify which browsers of devices or computers have been activated and operable with the password management systems herein. The current browser (This Browser) through which a user accesses a system may be identified as having been “activated” or “not activated.” Other browsers (Activated Browsers) may be listed as well corresponding to the password account of the user. The user can be given the option to perform various functions including deactivating each or all otherwise activated browsers or renaming them. For example, as shown in FIG. 17B, information about each browser or device may be also displayed such as the name of each browser (i.e., Work Browsers), the current browser and the last date/time the browser was used for an authentication process. Other browser information retrieved from and about each device may be displayed for identification and other purposes: Operating System: WinXP or WinVista, Browsers: Firefox 2.0 or Microsoft Internet Explorer 7.0, IP Address: 67.112.123.45, Created Date or when device was activated: Aug. 14, 2008. These and other pieces of device specific information may be used by the systems herein to detect and determine whether devices have been activated before proceeding to an authenticating process or display of the dynamic graphical image grids herein.

Users may be requested beforehand to activate the browser of their computers or devices on which authentications process will be performed. The password management systems herein may be able to detect whether or not users are logging in from an activated browser. A dialog box may be presented to a user when accessing a password account for the first time from an unactivated browser. An activation code may be generated by the system and delivered to the user according to a predetermined manner and channel. In some cases, activation codes may be delivered to more than one channel. For example, the user may define an email address (i.e., a Gmail account) as the destination to which activation codes are to be delivered.

The process of activation may include prompting the user for input such a personalized name for the browser of a device or computer (i.e., Home Browser, Work Browser). In addition, the user may be prompted for an activation number to be typed in by a user. This may be a soft token such as a six 6 digit number or code preferably through out-of-band (OOB) communication channels outside of the personal computer or browser environment such as by phone, email, and text messaging. The authentication grids or displays are preferably not displayed on a device until it is activated. So having possession of an access code derived from secret image categories (one factor), which changes in between authentication processes in any event, may not even allow presentation of an authentication display on a browser that is not yet activated. Devices that are shared or publicly accessible are preferably not activated in order to provide increased security. Accordingly, the combination of access codes (what a user knows) and activated browser (what a user has) provide two-factor authentication in accordance with an embodiment of the invention.

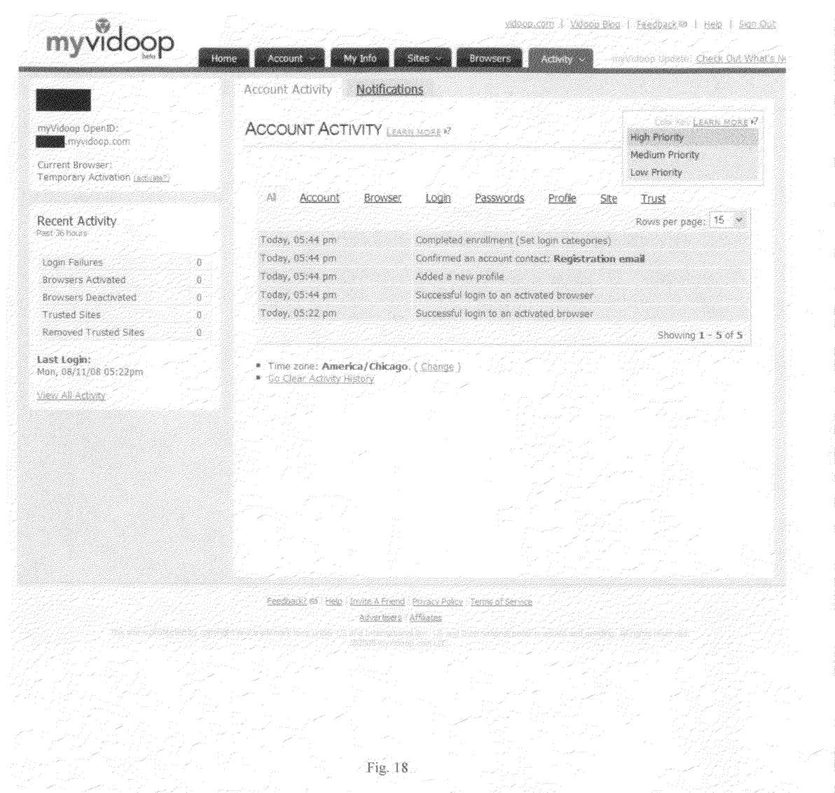

FIG. 18 shows a list of account activity for a password management account. An account activity page can be further provided to inform a user of any or all activity associated with a password account. The password management systems and methods provided in accordance with the invention offer users the ability to monitor, track and review various kinds of activities associated with the password account. Users can know from where, when and how their accounts are being used. As with other features of the systems provided herein, notifications (see notifications page) can be sent to user of activity that may be optionally categorized and/or prioritized in a predetermined manner.

For example, a user may select various pages from the account page to view either all activity or certain activities such as Account, Browser, Login, Passwords, Profile, Site and Trust activity. A user interface may be provided such that a user may select an activity category and the activities associated with that category may be listed below, and be somehow visually mapped to the appropriate category. For example, the selected category may be highlighted. In some embodiments, a user may be able to sort activities by category, such as when all activities are displayed, a user may be able to sort by account, browser, login, etc.

A log can be maintained for viewing by the user as to each group of activities which may be sorted according to the time in which events took place or their relative priority (i.e., High Priority/Medium Priority/Low Priority). In some embodiments, activity priority may be indicated by some sort of visual indicator such as color, symbol, shape, size, and so forth. A key may be provided to inform a user about how the visual indicator relates to relative priority.

Viewing may be made easier by allowing the user to select how many events for each kind of activity are displayed on each page (5, 15, 25, 50, 100). A user may also have options to change the user's time zone, or to clear activity history.

Many embodiments of the invention can provide dynamic image authentication arrangements that can be incorporated into existing authentication systems for preventing unauthorized access. Because cyber crimes often begin with unauthorized users gaining access to accounts to online accounts and applications, concepts of the invention herein can be implemented to create a first line of defense that provides stronger user authentication. Various embodiments of the invention provide secure login routines for user authentication that are effective against many prevalent forms of hacking, including historic threats like phishing, as well as new and growing threats like brute-force attacks, keystroke logging, and man-in-the-middle (MITM) spying. Additional embodiments of the invention can be modified for a variety of applications including network login, virtual private network (VPN) access, and web-based applications and web sites.

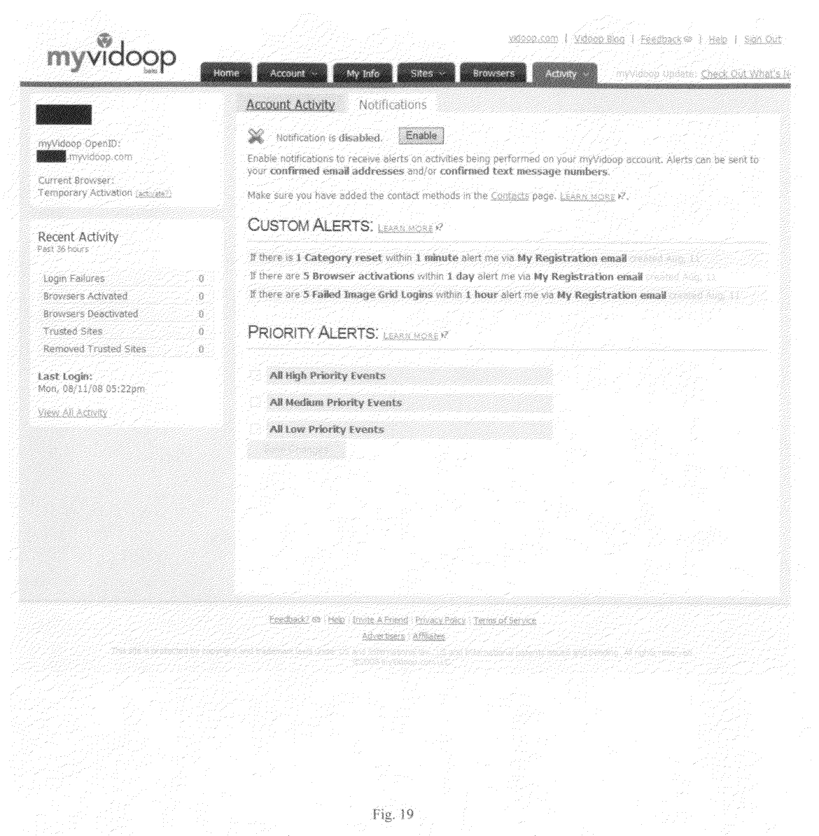

FIG. 19 shows a notifications page for a password management account. A notifications page or tab may be also provided under an accounts or activity page or tab that allows users to select how and/or if they want to be notified of account activity. This notification feature may be enabled or disabled upon user request and may pertain to any features offered in accordance with various aspects of the invention herein (see account activity page).

When enabled, a user can be notified over a selected channel of communication of certain activity. For example, the user may choose to receive updates or notifications via an email account, a cell phone or text message number which may be already included or entered in the contacts page. The user may want to be notified of events such as: multiple login failures within a relatively short period of time which could suggest someone is trying to hack into an account; or successful logins when the user did not actually access an account which could suggest a breach in the selection of secret image categories. Moreover, the kinds of alerts or activities to be monitored can be user defined and referred to as custom alerts. A user may be alerted of certain kinds and certain frequency of events related to a password account provided in accordance with this aspect of the invention (e.g., Alert me of 3 Failed Activations within 15 minutes of each other, Alert me of 3 Computer Deactivations within 15 minutes of each other, Alert me of 3 Notification Deactivations within 15 minutes of each other, Alert me of 3 Failed Image Grid Logins within 15 minutes of each other, Alert me of 3 Account Contact Removals within 15 minutes of each other).

In addition, pre-set alerts may be offered to the user so that notifications can be sent depending on account activity previously categorized as low, medium or high priority events. For example, the user may be notified of events such as the following: High Priority Activities such as failed activations, account contact updates, computer activations, new account contacts, new trusted sites, default profile changes, image categories resets, failed image grid logins, security level updates, notification deactivations; Medium Priority Activities such as successful and/or failed logins, do not trust sites, trusted site logins, account contact confirmations, one-time trusts, image categories changes password safe logins; and Low Priority Activities such as profile updates, trusted site updates, renamed computers, new profiles created, account contact removals, profile removals, trusted site removals, computer deactivations, enrollment completions, update image code colors, new passwords, password updates, password removals. Notifications for any or all of these prioritized or other events can be turned on/off by the user.

Another aspect of the invention provides methods for managing image-based password accounts. A user may also manage user access to other accounts. The invention also provides methods for authenticating a user to one or more remote web site. A user may be authenticated at a website by undergoing image-based authentication, accessing a password management account, selecting another account to access, and being directed to and authenticated at the other account. Any of the apparatuses, systems, or password management account embodiments as discussed herein and as known in the art may be used in implementing such methods.

One aspect of the invention may incorporate advertisements. Any of the images displayed for image-based authentication may include advertisements. Because the user is conducting an authentication process, it is highly likely that the user is giving his/her full or undivided attention to the graphical image and its corresponding image identifier. This level of attention and ability to target advertising based on a preselected category of images by a user creates a powerful marketing and advertisement opportunity. Preferable embodiments of the invention may be extended by replacing or augmenting the images in the image grid with audio, video, or other forms of media or multimedia. This aspect of the invention provides a number of other preferable embodiments or models as set forth in further detail herein. In some embodiments, a password management account may enable a user to provide advertisement specifications. For example, a password management account may allow a user to determine whether images used for authentication may comprise advertisements. In another example, a user may specify advertisement parameters, such as whether to allow audio or video content, the number of advertisements, whether to allow links or popups, whether to only display advertisements related to certain categories, etc.

The images in the database for this embodiment may contain advertisement images provided by advertisers. For instance, the image selected be displayed on the grid may be based on the web sites, the advertisement campaigns, and other parameters. When the user places the cursor over the image, additional information and links about the advertisement may be provided (which could otherwise be displayed automatically without cursor movement by the user). If the user chooses to follow an advertisement link, the destination of the link may open in a new window. When the user finishes browsing the advertisement web site, the user may return to the login screen.

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents.

What is claimed is:

1. A method for managing a password account within a system for managing image-based password accounts comprising:
providing a user interface to manage user account information within a system for managing image-based password accounts;
providing a user interface to customize image-based authentication parameters;
storing a plurality of passwords associated with one or more web sites within the system for managing image-based password accounts, wherein the one or more passwords are retrieved in response to a given event.

2. The method of claim 1 further comprising transmitting the retrieved passwords to the associated web site and authenticating the user at the associated web site in response to the given event.

3. The method of claim 1 further comprising providing a user interface to display account activity for the image-based authentication account.

4. The method of claim 1 further comprising providing a user interface to manage at least one of: one or more computers associated with the image-based authentication account; one or more browsers associated with the image-based authentication account; or one or more external devices associated with the image-based authentication account.

5. The method of claim 1 further comprising providing a user interface to customize alerts provided to a user contact.

6. The method of claim 1 further comprising storing user associated information wherein the user associated information is received and transmitted to a target location in response to a given event.

7. A method for authenticating a user on one or more remote web site comprising:
authenticating a user by verifying user recognition of at least one authenticating image category;
receiving a user request to access a remote web site;
retrieving the user's authentication information associated with the remote web site from a system for managing image-based password accounts;
directing the user to the remote web site; and
filling in the user's authentication information and authenticating the user at the remote web site through the system for managing image-based password accounts.

8. The method of claim 7 wherein verifying user recognition of at least one image category comprises:
generating a graphical arrangement of images having at least one image selected from an authenticating image category and at least one image selected from a non-authenticating category, each image having a corresponding access code;
receiving as input from the user the series of one or more access codes corresponding to images from the authenticating image category; and
comparing the series of one or more access codes to an authenticating reference code to verify user recognition and authenticate the user.

9. The method of claim 7 further comprising displaying one or more identifier for one or more trusted web site.

10. The method of claim 9 further comprising providing a user interface to add or manage the trusted web sites or the user's authentication information.

11. An image-based authentication system comprising:
a user interface configured to allow a user to customize one or more authentication parameters that provide access to a plurality of user accounts,
wherein customizing one or more authentication parameters includes at least one of the following: selecting or modifying an authenticating image category, specifying a graphical authentication display setting, or selecting or modifying an access code background color.

12. The system of claim 11 wherein specifying a graphical authentication display setting includes modifying the number of images displayed or determining whether the order of the access code matters for authentication.

13. A password management system comprising:
an initial user authentication interface configured to authenticate a user by verifying user recognition of at least one authenticating image category
a user interface configured to provide access to one or more listed remote web sites, wherein selecting a listed remote web site directs a user to the remote web site and automatically provides the user's authentication information for the remote web site and authenticates the user at the remote web site.

14. The system of claim 13 further comprising a plug-in configured to automatically provide the user's authentication information for the remote web site and to authenticate the user at the remote web site.

15. A password management system comprising:
a page configured to display password account activity comprising:
one or more activity categories, wherein at least one of the activity categories is selected; and
an account activity listing, wherein the account activity listing includes activities that are associated with a selected activity category.

16. The system of claim 15 wherein the account activity listing includes a priority indicator for each activity listed.

17. The system of claim 15 further comprising
a page configured allow a user to customize alerts, wherein alerts may include activities sorted by a characteristic.

18. The system of claim 17 wherein the characteristic is a priority or a category.

19. A method for image-based password registration comprising:
selecting and storing at least one authenticating image category;
generating a practice display including a graphical arrangement of images having the at least one authenticating image category, wherein the at least one authenticating image has a corresponding access code;
verifying user recognition of the at least one authenticating image category; and confirming the at least one authenticating image category.

20. The method of claim 19 further comprising:
receiving account information associated with the user; and
confirming the account information associated with the user.

21. The method of claim 19 wherein verifying user recognition comprises:
receiving as input from the user the series of one or more access codes corresponding to images from the authenticating image category; and
comparing the series of one or more access codes to an authenticating reference code to verify user recognition.
